(19) United States
(12) Patent Application Publication
(10) Pub. No.: US 2026/0079130 A1
(43) Pub. Date: Mar. 19, 2026

(54) ENGAGEMENT ASSEMBLIES FOR SYNCHRONIZING ROTATIONAL AND TRANSLATIONAL MOTION WITH ULTRASONIC MEASUREMENTS

(71) Applicant: HEXAGON TECHNOLOGY AS, Alesund (NO)

(72) Inventors: Brian Burks, Parker, CO (US); Gabriel Kalmar, Centennial, CO (US); William Charlesworth, Denver, CO (US); Troy Otto, Aurora, CO (US); Phi Tran, Westminster, CO (US)

(21) Appl. No.: 19/396,052

(22) Filed: Nov. 20, 2025

Related U.S. Application Data
(63) Continuation-in-part of application No. PCT/IB2024/061064, filed on Nov. 7, 2024.
(60) Provisional application No. 63/547,754, filed on Nov. 8, 2023.

(51) Int. Cl. G01N 29/04; G01D 5/347; G01N 29/265

(52) U.S. Cl. CPC G01N 29/04; G01D 5/3473; G01N 29/265; G01N 2291/023; G01N 2291/0289; G01N 2291/101; G01N 2291/2634

(57) ABSTRACT

A non-direct drive cylinder defect detection system is disclosed. A non-direct drivetrain system may include a plurality of rollers rotatably driven by a shaft. The plurality of rollers can receive and cause a tube to spin while rested thereon. An encoder system is disclosed and is configured to detect a rotary position of a portion of the tube.

### CROSS-REFERENCE TO RELATED APPLICATIONS

This application is a continuation-in-part of International Application No. PCT/IB2024/061064, filed Nov. 7, 2024, which designates the United States and was published in English by the International Bureau on May 15, 2025 as WO2025/099648, which claims the benefit of U.S. Provisional Application No. 63/547,754, filed Nov. 8, 2023, the entire contents of each of which are hereby incorporated by reference.

### FIELD

This disclosure relates to testing of tubes for defects such as cracks, wall thinning, or other forms of defects.

### BACKGROUND

Having precise control over the synchronization of rotational and translational motion is critical to effectively employing automated ultrasound scanners that are often used in the periodic inspection of seamless metallic cylinders. For example, many national body and international standards require that a 10% overlap in the ultrasound measurements be kept so as to not avoid missing a rejectable defect.

A penalty in use of a direct drive drivetrain system is that cylinder handling and motion may become complicated due to a need to position the center line of cylinders (e.g., having variable diameter) at the centerline of the drivetrain when the ultrasound inspection is to be performed.

Previous automated ultrasound systems that employ non direct drive drivetrains rely on allowing the cylinder to lay on a bed of rollers which are attached to shafts which are rotated by a motor. In operation, the self weight of the cylinder and the frictional force between the cylinder and bed of rollers may result in rotational motion of the cylinder when the motor that is connected to the shafts operates. One drawback with such systems is mechanical slip between the cylinder and the bed of rollers. Such drawbacks would also exist with the testing of tubes.

### SUMMARY

Aspects of this disclosure include a system for synchronizing rotational and translational motion of an ultrasound probe or scanning head with ultrasound measurements of a tube when the tube is rotated by a system whose drivetrain is not direct drive. Aspects of the present disclosure address mechanical slip issues present in the prior art.

In some aspects, a non-direct drive tube defect detection system is disclosed. The system may include a non-direct drivetrain system comprising a plurality of rollers rotatably driven by a shaft, the plurality of rollers configured to receive and cause a tube to spin while rested thereon; and an encoder system including an engagement assembly for engaging with an interior surface of the tube, the encoder system configured to detect a rotary position of a portion of the tube.

In some aspects, the engagement assembly is configured to apply a radial force to the tube to engage with the tube.

In some aspects, the engagement assembly includes one or more friction surfaces for applying friction to the tube to engage with the tube.

In some aspects, the engagement assembly includes one or more suction devices for applying suction to the tube to engage with the tube.

In some aspects, the engagement assembly includes one or more arm assemblies for engagement with the tube.

In some aspects, each arm assembly includes a friction surface for applying friction to the tube to engage with the tube.

In some aspects, each arm assembly is configured to move radially outward for engagement with the tube.

In some aspects, each arm assembly includes a suction device for engagement with the tube.

In some aspects, each arm assembly is configured to be positioned within an interior channel of the tube.

In some aspects, the engagement assembly includes a pneumatic system.

In some aspects, the pneumatic system is configured to produce an engagement force with the tube to engage with the tube.

In some aspects, the engagement force is a radially outward force.

In some aspects, the engagement force is a suction force.

In some aspects, the engagement assembly includes one or more arm assemblies and the pneumatic system is configured to move the one or more arm assemblies radially outward to engage with the tube.

In some aspects, the engagement assembly includes one or more springs configured to retract the one or more arm assemblies radially inward.

In some aspects, the pneumatic system is configured to apply force to a mechanical interface to move the one or more arm assemblies radially outward to engage with the tube.

In some aspects, the pneumatic system includes a pneumatic actuator.

In some aspects, the engagement assembly includes at least one lever arm linkage.

In some aspects, the at least one lever arm linkage is configured to extend radially outward towards an interior surface of the tube.

In some aspects, the engagement assembly includes a pneumatic actuator, and the at least one lever arm linkage includes a first portion coupled to the pneumatic actuator and a second portion coupled to a base, and the pneumatic actuator is configured to move towards the base to extend the at least one lever arm linkage radially outward.

In some aspects, the at least one lever arm linkage includes at least three lever arm linkages spaced circumferentially from each other.

In some aspects, the at least one lever arm linkage is configured to slide along at least one rail to extend radially outward towards the interior surface of the tube.

In some aspects, the at least one lever arm linkage is a scissor linkage.

In some aspects, the at least one lever arm linkage includes two of the scissor linkages each configured to expand in opposite directions from each other.

In some aspects, a friction surface is coupled to the at least one lever arm linkage for applying friction to the tube to engage with the tube.

In some aspects, a suction device is coupled to the at least one lever arm linkage for engagement with the tube.

In some aspects, the at least one lever arm linkage includes at least three of the lever arm linkages spaced circumferentially from each other, and the system further comprises at least three suction devices each being coupled to a respective one of the at least three lever arm linkages.

In some aspects, the encoder system includes a rotational bearing configured to allow at least a portion of the engagement assembly to rotate with the tube.

In some aspects, the encoder system includes a rotary encoder configured to detect the rotary position of the portion of the tube.

In some aspects, the rotary encoder is configured to detect a rotary position of the engagement assembly to detect the rotary position of the portion of the tube.

In some aspects, an adjustable receiving/transmitting transducer is positioned to mount proximal to the tube.

In some aspects, the non-direct drivetrain system comprises a motor coupled to a gear box, wherein the gear box is coupled to an output shaft that passes through a bearing housing mounted in a wall of a fluid tank and into contact with the plurality of rollers.

In some aspects, a fluid tank is provided for providing fluid for use in testing operations.

In some aspects, the tube is provided.

In some aspects, at least a portion of the engagement assembly is configured to be positioned within an interior channel of the tube.

In some aspects, a method is disclosed for testing for the presence of a tube defect. The method includes arranging at least a portion of a tube in a measuring position relative to a plurality of rollers and an encoder system of a non-direct drive ultrasonic scanning system; engaging an engagement assembly of the encoder system with an interior surface of the tube; spinning, by the plurality of rollers, the tube; moving an ultrasonic transducer into proximity with the tube; detecting, by the encoder system, a rotary position of a portion of the tube; synchronizing, based on the rotary position, rotational and translational motion of an ultrasonic transducer of the non-direct drive ultrasonic scanning system; and determining, using the rotary position and signals from the ultrasonic transducer of the non-direct drive ultrasonic scanning system, whether a defect of the tube is present.

In some aspects, the encoder system is any encoder system according to this disclosure.

In some aspects, the tube is any tube according to this disclosure.

In some aspects, the method further comprises detecting, by the ultrasonic transducer, a set of signals resulting from a set of ultrasonic pulses.

In some aspects, the method further comprises positioning at least a portion of the engagement assembly within an interior channel of the tube.

In some aspects, provided herein are examples of coupling an auxiliary rotational encoder to a tube under test being driven by a non direct drive drivetrain while using the feedback from the auxiliary rotational encoder to synchronize the rotational and translational motion of the scanning head and the ultrasound pulser receiver unit so that precise control of where measurements are made on the tube surface are divulged. The examples described herein overcome the issue of mechanical slippage possible in non direct drive systems ensuring that national body and international periodic inspections are performed properly.

To the accomplishment of the foregoing and related ends, certain illustrative aspects are described herein in connection with the following description and the appended drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

The above and further aspects of this invention are further discussed with reference to the following description in conjunction with the accompanying drawings, in which like numerals indicate like structural elements and features in various figures. The drawings are not necessarily to scale, emphasis instead being placed upon illustrating principles of the invention. The figures depict one or more implementations of the inventive devices, by way of example only, not by way of limitation.

FIG. 1 is a top view drawing of a direct-drive ultrasonic scanning system.

FIG. 2 is a front view drawing of a direct-drive ultrasonic scanning system.

FIG. 3 is a perspective view of an ultrasonic cylinder scanning system with one or more non-direct drivetrains.

FIG. 4 is a perspective view of an example rotary encoder system for use with the ultrasonic cylinder scanning system of FIG. 3.

FIG. 5 is a perspective view of an example rotary encoder system for use with the ultrasonic cylinder scanning system of FIG. 3.

FIG. 6A is a perspective view of an example cylinder for use with an example rotary encoder system of the ultrasonic cylinder scanning system of FIG. 3.

FIG. 6B is a close-up of section 6B-6B of FIG. 6A.

FIG. 7A is a perspective view of an example cylinder for use with an example rotary encoder system of the ultrasonic cylinder scanning system of FIG. 3.

FIG. 7B is a close-up of section 7B-7B of FIG. 7A.

FIG. 8A is a perspective view of an example cylinder for use with an example rotary encoder system of the ultrasonic cylinder scanning system of FIG. 3.

FIG. 8B is a close-up of section 8B-8B of FIG. 8A.

FIG. 9 is a flow chart of operating an example rotary encoder system, according to the present disclosure.

FIG. 10 is a computer architecture diagram showing a computing system for implementing aspects of the present disclosure in accordance with one or more examples described herein.

FIG. 11 is a perspective view of a tube.

FIG. 12 is a cross sectional view of the tube of FIG. 11.

FIG. 13 is a front perspective view of an example rotary encoder system.

FIG. 14 is a rear perspective view of the example rotary encoder system of FIG. 13.

FIG. 15 is a front perspective view of the example rotary encoder system of FIG. 13 with a portion of a base removed.

FIG. 16 is a front perspective view of the example rotary encoder system of FIG. 13 with arm assemblies retracted.

FIG. 17 is a side cross sectional view of the example rotary encoder system of FIG. 13.

FIG. 18 is a cross sectional view of the tube of FIG. 11 with the example rotary encoder system of FIG. 13 positioned therein.

FIG. 19 is a front perspective view of an example rotary encoder system.

FIG. 20 is a front perspective view of an example rotary encoder system.

FIG. 21 is a front perspective view of the example rotary encoder system of FIG. 20 with arm assemblies extended radially outward.

FIG. 22 is a rear perspective view of the example rotary encoder system of FIG. 20 with arm assemblies extended radially outward.

FIG. 23 is a side cross sectional view of the example rotary encoder system of FIG. 20.

FIG. 24 is a front perspective view of an example rotary encoder system.

FIG. 25 is a front view of the example rotary encoder system of FIG. 24.

FIG. 26 is a side view of the example rotary encoder system of FIG. 24.

FIG. 27 is a cross sectional perspective view of the example rotary encoder system of FIG. 24.

FIG. 28 is a front perspective view of the example rotary encoder system of FIG. 24 with arm assemblies extended radially outward.

FIG. 29 is a front view of the example rotary encoder system of FIG. 24 with arm assemblies extended radially outward.

FIG. 30 is a front perspective view of an example rotary encoder system.

FIG. 31 is a cross sectional perspective view of the example rotary encoder system of FIG. 30.

FIG. 32 is a front perspective view of the example rotary encoder system of FIG. 30 with arm assemblies extended radially outward.

FIG. 33 is a front perspective view of an example rotary encoder system.

FIG. 34 is a front perspective view of the example rotary encoder system of FIG. 33 with a plate removed.

FIG. 35 is a cross sectional perspective view of the example rotary encoder system of FIG. 33.

FIG. 36 is a side view of the example rotary encoder system of FIG. 33.

FIG. 37 is a side view of the example rotary encoder system of FIG. 33.

### DETAILED DESCRIPTION

Although examples of the disclosed technology are explained in detail herein, it is to be understood that other examples are contemplated. Accordingly, it is not intended that the disclosed technology be limited in its scope to the details of construction and arrangement of components set forth in the following description or illustrated in the drawings. The disclosed technology is capable of other examples and/or of being practiced or carried out in various ways.

It must also be noted that, as used in the specification and the appended claims, the singular forms “a,” “an” and “the” include plural referents unless the context clearly dictates otherwise. By “comprising” or “containing” or “including” it is meant that at least the named compound, element, particle, or method step is present in the composition or article or method, but does not exclude the presence of other compounds, materials, particles, method steps, even if the other such compounds, material, particles, method steps have the same function as what is named.

Relative terms, such as “about,” “substantially,” or “approximately” are used to include small variations with specific numerical values (e.g., +/−x%,), as well as including the situation of no variation (+/−0%). In some examples, the numerical value x is less than or equal to 10 —e.g., less than or equal to 5, to 2, to 1, or smaller.

The mention of one or more steps of a method does not preclude the presence of additional method steps or intervening method steps between those steps expressly identified. Steps of a method may be performed in a different order than those described herein without departing from the scope of the disclosed technology. Similarly, it is also to be understood that the mention of one or more components in a device or system does not preclude the presence of additional components or intervening components between those components expressly identified.

A variety of ultrasonic testing methods and equipment for ultrasonic testing of cylinders are described U.S. Pat. No. 6,851,319 B2 issued Feb. 8, 2005, which is incorporated by reference in its entirety for all purposes as if set forth verbatim herein.

As discussed herein, “operator” may include, but is not limited to, a technician, an engineer, or other professional, or any other suitable individual associated with the ultrasonic testing of cylinders or tubes.

The terms “distal” or “proximal” are used in the following description with respect to a position or direction relative to a reference point. “Distal” or “distally” are a position distant from or in a direction away from the reference point. “Proximal” or “proximally” or “proximate” are a position near or in a direction toward the reference point.

In some aspects, the present disclosure provides a description of devices, systems, and methods to meet requirements under certain governing bodies (e.g., Department of Transportation (DOT)) for the ultrasonic testing or retesting of cylinders for certain defects and to measure cylinder wall thickness. For example, DOT requires that cylinders used for over-the-road transportation of pressurized gases and liquids be retested at periodic intervals to ensure that no defects of a critical size exist in the cylinders. Testing of tubes may also occur.

The term, “cylinder” and other types of containers of this disclosure are typically made of steel but can also be aluminum or some other metal (or even certain plastics or other polymers) or other materials depending on the application.

Although often discussed herein simply in terms of cylinders for convenience and illustration, it will be recognized that pipes, tanks, plates, spheres and other container structures can be tested using the methods and devices herein. That is, the methods herein are suitable to a variety of container configurations (pipes, spheres, plates, tanks, etc.) and are especially applicable to cylindrical objects like gas cylinders and pipes or other objects. The cylinders in implementations herein may include valves (cylinder valves) as desired. Tubes may also be tested according to methods herein.

Cracks in cylinder walls can be oriented axially or circumferentially. In either case, the crack surface can be tilted away from perpendicular to the cylinder surface, which may change the reflection intensity of a delivered ultrasonic beam, depending on the angle between the beam and the crack. Tubes may similarly include such features.

### DESCRIPTION OF DIRECT DRIVE SYSTEMS

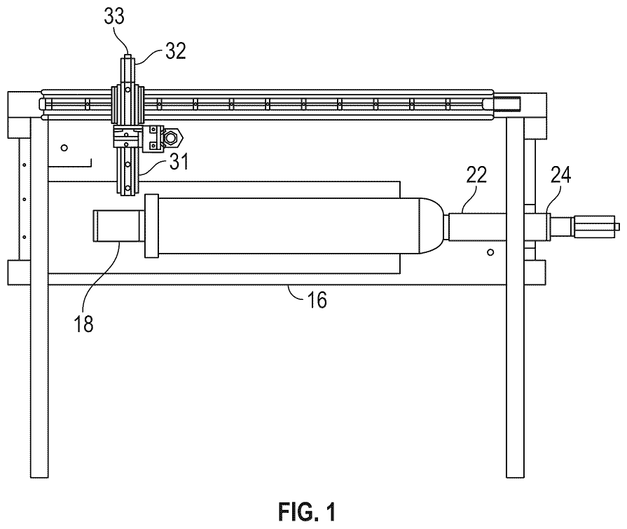

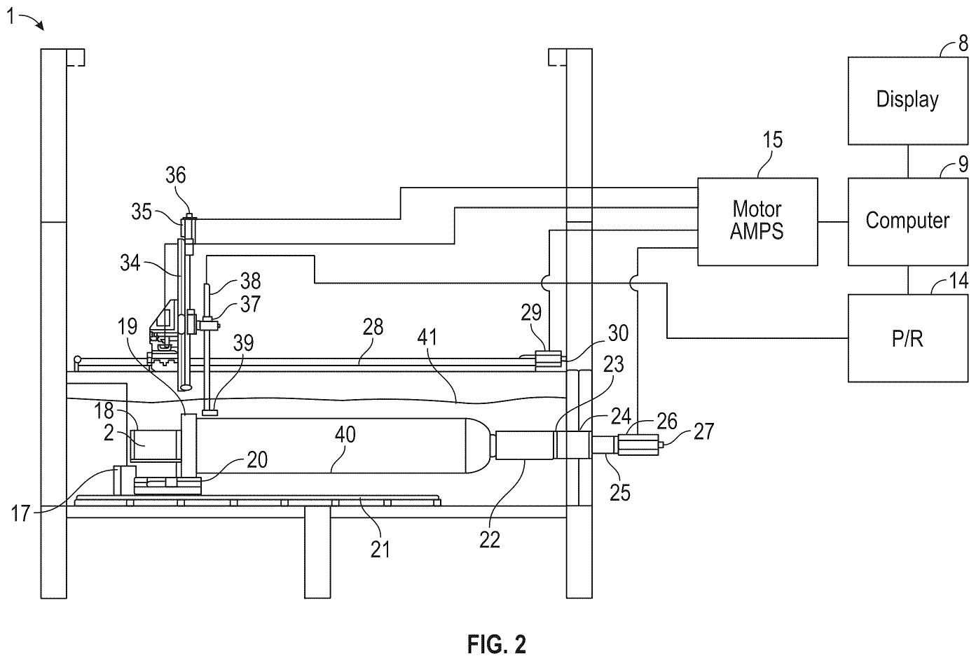

FIGS. 1-2 depict an ultrasonic scanning system 1 of previous disclosure, U.S. Pat. No. 6,851,319, issued Feb. 8, 2005, which is a direct-drive system and which is incorporated by reference in its entirety for all purposes. As shown, system 1 can include display 8, computer 9, a pulser/receiver module 14, motor amplifiers 15, tank 16, pneumatic cylinder 17, tailstock assembly 2 (which includes, e.g., bearing housing 18, cup 19, linear slide 20, and tailstock linear slide 21), self-centering cap 22, output shaft 23, bearing housing 24, gear box 25, rotary motor 26, rotary motor encoder 27, x-axis linear table 28, x-axis motor 29, x-axis encoder 30, y-axis linear table 31, y-axis motor 32, y-axis encoder 33, z-axis linear table 34, z-axis motor 35, z-axis encoder 36, rotatable search tube holder 37, search tube 38, ultrasonic sensor 39, cylinder 40, and coupling fluid 41.

When in use, the tank 16 of system 1 is filled with coupling fluid 41 (e.g., water). Cylinder 40 is placed in the tank between cup 19 and self-centering cap 22. Pneumatic cylinder 17 is then activated, moving the tailstock assembly along linear slide 20. This forces the cylinder into intimate contact with cup 19 and self-centering cap 22. Various lengths of cylinders are accommodated by adjusting the tailstock location along tailstock linear slide 21 and locking the tailstock assembly into place. Bearing housing 18 allows cup 19 to spin. In system 1, cylinder 40 is spun by activating rotary motor 26. Rotary motor 26 is attached to gear box 25. Gear box 25 is attached to output shaft 23 through bearing housing 24, and self-centering cap 22 is attached to output shaft 23.

In system 1, ultrasonic sensor 39 is held in position by being attached to rigid search tube 38. Search tube 38 is mounted in rotatable search tube holder 37, which is then attached to z-axis linear table 34. Ultrasonic sensor 39 is positioned relative to cylinder 40 by activating x-axis motor 29, y-axis motor 32, and z-axis motor 35. The motion is constrained by x-axis linear table 28, y-axis linear table 31 and z-axis linear table 34. An x-y-z position of the sensor is determined by encoder outputs of x-axis encoder 30, y-axis encoder 33, and z-axis encoder 36. Sensor position is read by computer 9 using motion control hardware. Motor amplifiers 15 provide power to the motors.

In system 1, as cylinder 40 is spun, ultrasonic sensor 39 is translated the length of cylinder 40 by x-axis linear table 28. The spinning and linear translation create a helix down the length of the cylinder. The rotary position of the cylinder is determined by the output of the rotary motor encoder 27. Output of rotary motor encoder 27 is read by a counter on trigger board and used to trigger pulser/receiver module 14. At specific intervals determined by the user, a high voltage electrical pulse from pulser/receiver module 14 is sent to ultrasonic sensor 39. This creates an ultrasonic pulse that propagates through coupling fluid 41 and into a wall of cylinder 40. The pulse echoes back from the wall of cylinder 40, and is detected by ultrasonic sensor 39. Ultrasonic sensor 39 sends a signal to pulser/receiver module 14, which amplifies and filters the received signal and sends a trigger pulse to an A/D converter. The signal is then digitized by the A/D converter, and then stored in an electronic format for analysis by software.

### DESCRIPTION OF EXAMPLE NON-DIRECT DRIVES

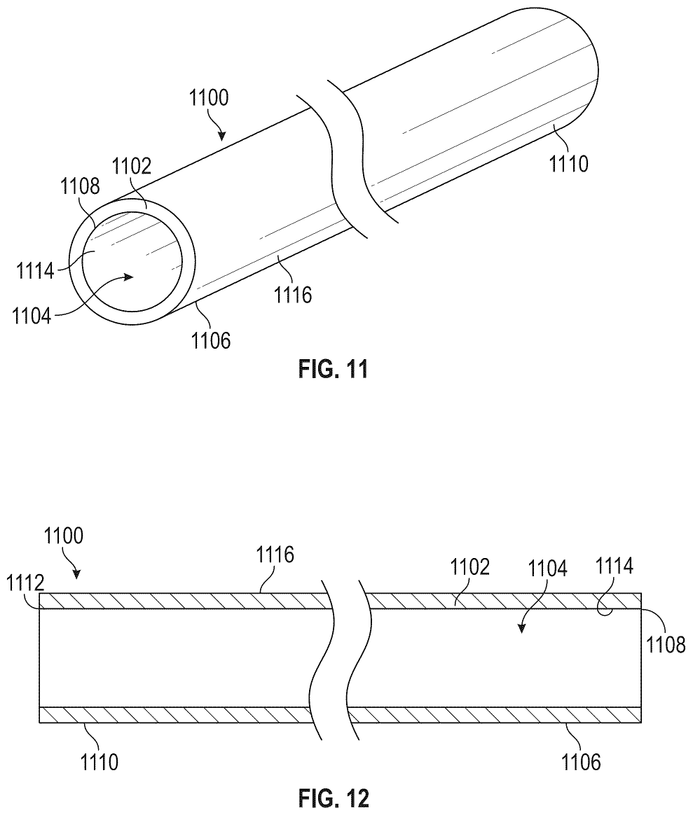

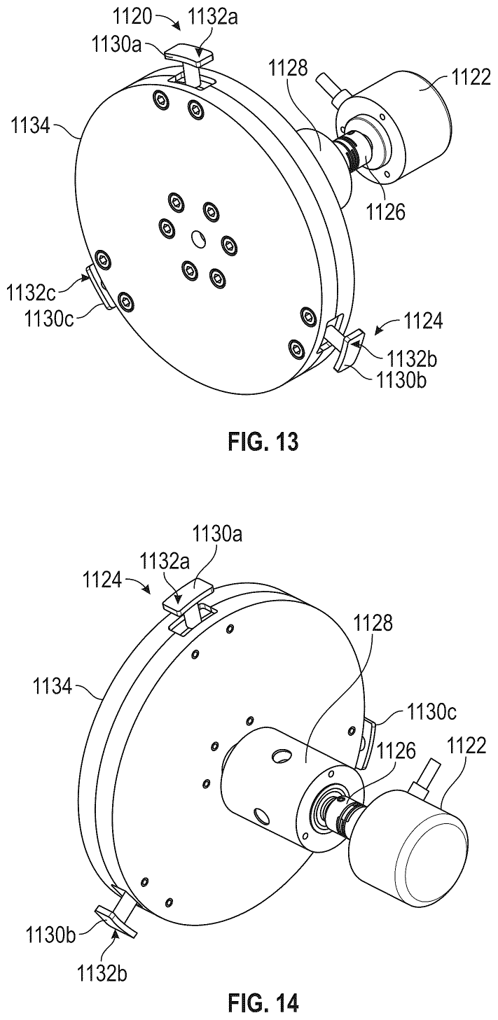

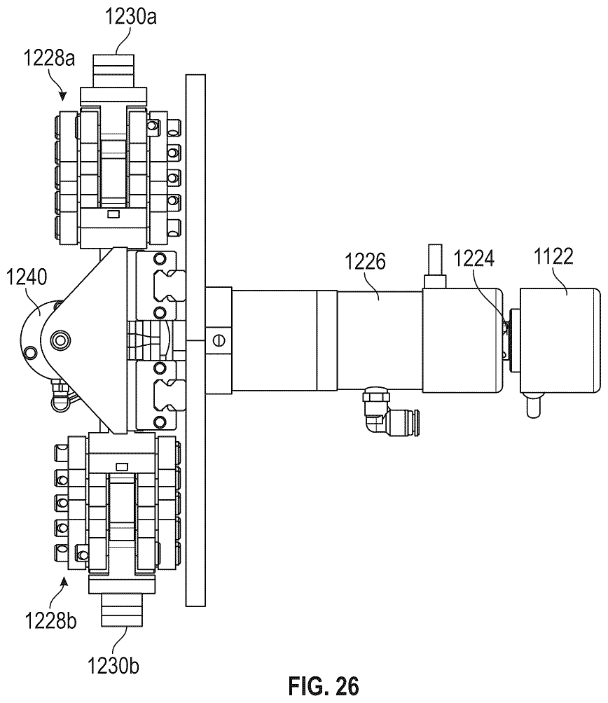

Turning to FIG. 3, a perspective view is provided of an ultrasonic cylinder scanning system 300 with one or more non-direct drivetrains. As shown, system 300 can include one or more rollers 315 in a tank 16 to cause the previously described cylinder 40 to rotate while rested thereon (e.g., positioned on top of the rollers 315). The rollers 315 are driven by a shaft 316. The system that causes the rollers 315 to rotate may include mechanical features as disclosed in regard to the system 1, for example, the cylinder 40 is spun by activating a rotary motor 317, which may be attached to a gear box, which may couple to a gear pulley 319. The gear box is accordingly attached to the shaft 316, which may pass through a bearing housing mounted in a wall of a fluid tank and into contact with the rollers 315. The testing may occur within a fluid tank. The rollers 315 receive and cause the cylinder 40 to spin while rested thereon. The rollers 315 rotate the cylinder 40 with friction. Any mechanical feature as disclosed in regard to the system 1 may be utilized. Further, the ultrasonic sensor 39 may be utilized in a manner disclosed in regard to the system 1. Testing utilizing the ultrasonic sensor 39 may be utilized in a manner disclosed in regard to the system 1. As previously noted, there can be slippage between the one or more rollers 315 and cylinder 40 during testing operations when cylinder 40 is being spun. The following examples address this slippage by synchronizing the rotational, translational, and ultrasound measurements, which ensures the integrity of any tests conducted using system 300. The features of FIGS. 13-37 may utilize the system 300, yet for testing of a tube (as represented in FIG. 11 for example).

By synchronizing the rotational, translational, and ultrasound measurements, the most accurate ultrasonic C-scan is obtained. Historically, this has been accomplished with a direct drivetrain. However, with the systems and methods disclosed herein, the auxiliary encoder, coupled directly to the rotating cylinder under test in a non-slip fashion, may provide the same level of information that the encoder of the rotational motor did in the direct drivetrain configuration. With the most accurate possible C-scan (i.e., defects not being skewed due to slip of the cylinder under test), defects from gas pressure cylinders (with principal stress axes in the axial and circumferential direction) will be perfectly aligned with the principal stress directions which aids automated flaw detection algorithms in properly identifying rejectable defects. Similar features may be utilized with a tube under test.

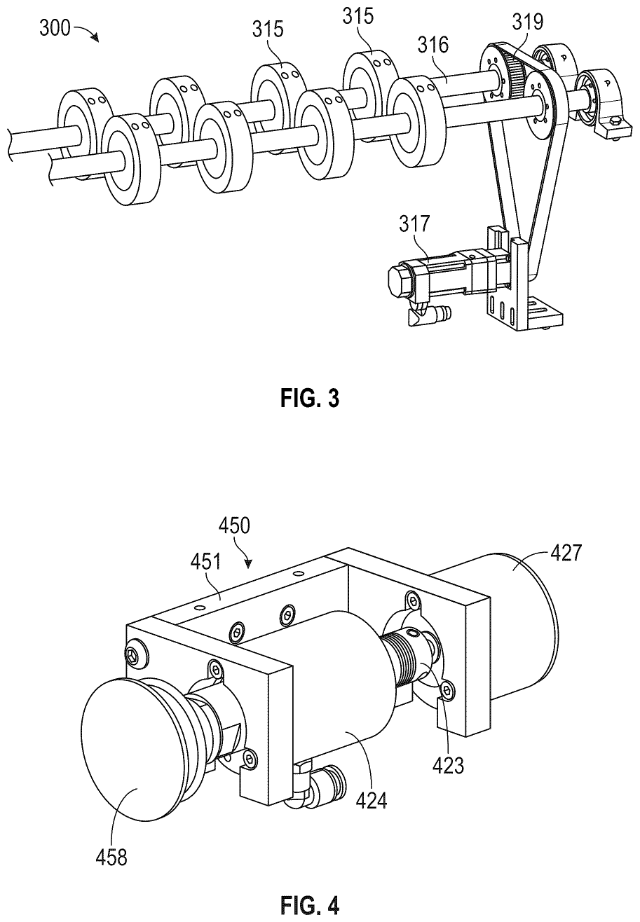

The examples of any of FIGS. 4-10 may be utilized with the ultrasonic cylinder scanning system 300 of FIG. 3. Turning to FIG. 4, an example rotary encoder system 450 is illustrated. The encoder system 450 is configured to detect a rotary position of a portion of the cylinder 40. The portion may comprise a base portion of the cylinder 40 in aspects herein. System 450 can include one or more rotary encoders 427 with a rotating shaft 423 that runs from encoder 427 through a vacuum rotary union housing 424. It is noted in all examples herein (e.g., the examples of any of FIGS. 1-37) a rotary encoder with a rotating shaft coupled thereto may be utilized, yet in any of these examples other types of encoders may also be utilized such as a hollow shaft encoder configured to be disposed around a rotating shaft (e.g., rotating shaft 423 or the corresponding rotating shaft of the examples herein). Housing 424 can be positioned within a mount 451 that can attach directly to aspects of prior described system 300 (e.g., housing mounted in a wall of a fluid tank). One or more vacuum sealing cups 458 can be positioned on a distal end of shaft 423 and distal of mount 451. In some aspects, the one or more cups 458 can be configured to connect to a distal end of a cylinder 40 during testing operations (e.g., mechanically attach to by forming a vacuum seal coupling with a corresponding end of cylinder 40). The rotary encoder 427 has a rotating shaft 423 that is connected to the vacuum sealing cup 458. The rotary encoder 427 is configured to detect the rotary position of the end of the cylinder 40. In some aspects, the one or more cups can utilize one or more vacuum forces to adhere to cylinder 40. In some aspects, the example vacuum force between the one or more cups 458 and cylinder 40 can be sufficiently larger than any frictional drag capable of being developed in the rotary encoder 427 during testing operations (e.g., frictional drag developed in the rotary encoder 427 by rotation caused by the rotating shaft 423 during testing operations). System 450 is particularly advantageous since it can be used with any non-direct drive system, such as system 300, and with ferrous or non-ferrous cylinders 40.

During operations, after cylinder 40 and the one or more cups 458 have connected, then cylinder 40 is spun. The rotary position of cylinder 40 is determined by the output of encoder 427. Output of rotary encoder 427 is read (e.g., by a counter on a trigger board and used to trigger the ultrasound pulser/receiver module 14). Based on the detected rotary position, the system can synchronize any detected slippage based on the rotary position with rotational and translational motion of its ultrasonic transducer. The ultrasonic transducer may comprise an adjustable receiving/transmitting transducer positioned to mount proximal to the cylinder 40. In some aspects, at specific intervals measured by the rotary encoder, a high voltage electrical pulse from a pulser/receiver module can be sent to an ultrasonic sensor of the system. This creates an ultrasonic pulse that propagates and into a wall of cylinder 40. The pulse echoes back from the wall of cylinder 40 and is detected by the ultrasonic sensor. In some aspects, the ultrasonic sensor can send a signal to pulser/receiver module, which amplifies and filters the received signal and sends a trigger pulse to an A/D converter. The signal is then digitized by the A/D converter, and then stored in an electronic format for analysis by aspects of a connected computer system. All of these operations can take place in the non-direct drive system 300 while also accounting for slippage.

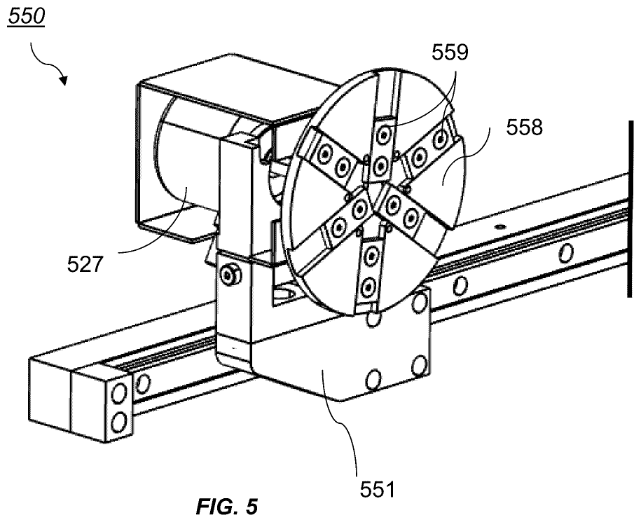

Turning to FIG. 5, another example rotary encoder system 550 is illustrated. System 550 can include one or more rotary encoders 527 with a rotating shaft that runs from encoder 527 through a mount 551 that can attach directly to aspects of prior described system 300, such as the illustrated linear table of FIG. 5. One or more connector plates 558 can be positioned on a distal end of the rotating shaft and distal of mount 551. In aspects, the rotary encoder 527 is coupled to a rotating shaft that runs from the rotary encoder 527 through the connector plate 558, the rotary encoder 527 configured to detect the rotary position of the end of the cylinder 40. In some aspects, the one or more plates 558 can be rotatable (e.g., with one or more rotational bearings) and be magnetic. In some aspects, the one or more plates 558 can be rotatable and include one or more embedded magnetic connectors 559. The connector plate 558 is driven by a rotating shaft and is configured to connect to an end of the cylinder 40, the connector plate 558 being at least partially magnetic or comprising one or more magnetic connectors 559.

Similar to system 450, system 550 can be configured to connect to a distal end of cylinder 40 during testing operations (e.g., mechanically attach to by forming a magnetic coupling with a corresponding end of cylinder 40 or the flange of a tube or any other cylinder being tested). In aspects, the cylinder 40 comprises a ferrous connector positioned on the end of the cylinder 40 to form the magnetic force between the cylinder 40 and the connector plate 558. In some aspects, the magnetic force formed by attaching one or more plates 558 to cylinder 40 under test is sufficiently large to overcome any mechanical drag force or other slippage which can be developed in the rotary encoder 527 (e.g., frictional drag developed in the rotary encoder 527 by rotation caused by the rotating shaft during testing operations). System 550 is particularly advantageous since it can be used with any non-direct drive system, such as system 300, and with ferrous cylinders 40.

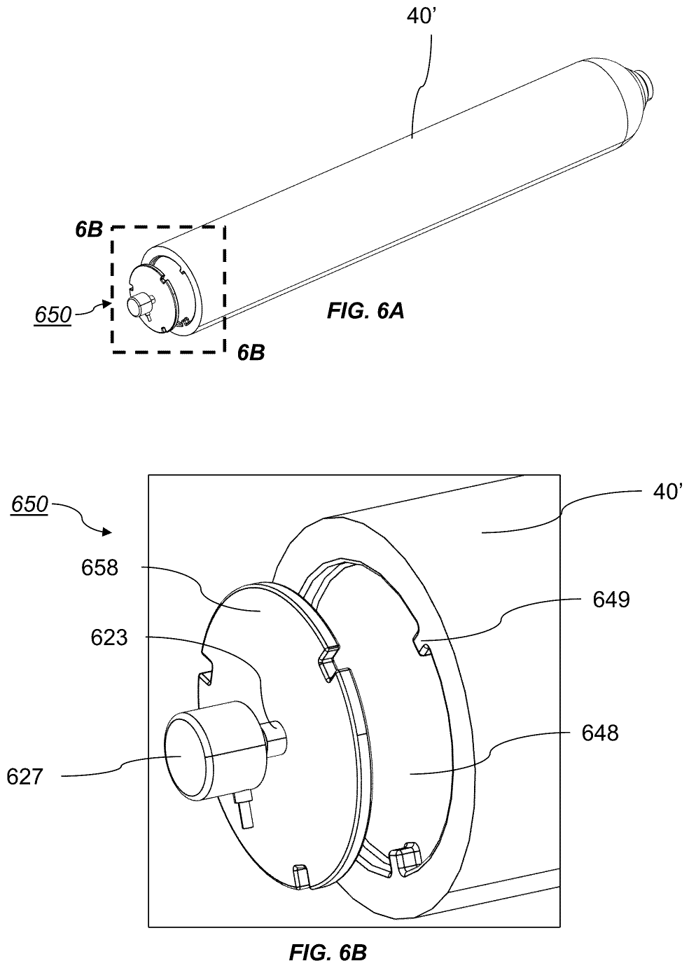

Turning to FIG. 6A, another example rotary encoder system 650 is illustrated in an exploded state with an example cylinder 40′, which is modified at its mounting end with respect to prior cylinders 40 of this disclosure. As further illustrated in FIG. 6B, which shows a close-up of section 6B-6B of FIG. 6A, modified cylinder 40′ here can include a coupling pattern or locating pattern at its base end or shaped in its base surface 648. Base surface 648 can include one or more notches 649 or other registration features that are selectively positioned to align with mounting plate 658 of system 650. The one or more notches 649 are formed in the base end and are selectively positioned to align with the mounting plate 658. Similar to prior examples, plate 658 can include a rotational bearing feature that is connected to the input shaft 623 of rotary encoder 627. During operations, plate 658 can mechanically lock and unlock to cylinder 40′ during testing operations. The mounting plate 658 is configured to connect to an end of the cylinder 40′, the mounting plate 658 including a coupling pattern or locating pattern shaped to connect with the coupling pattern or locating pattern of the cylinder 40′. In some aspects, as the cylinder 40′ is rotated the rotary encoder 627 can precisely track the circumferential position of cylinder 40′, similar to testing operations of previous rotational encoders of this disclosure. The rotary encoder 627 is configured to detect the rotary position of the end of the cylinder 40′. In some embodiments, cylinder 40′ is removably coupled to a base that has the locating pattern or coupling pattern shaped in its base surface. In this way, the base can be temporarily attached to a cylinder for testing, regardless of whether the cylinder has the locating pattern or coupling pattern shaped in its base surface. The removable base may be temporarily coupled to the cylinder using any method, such as interference fit or a temporary adhesive.

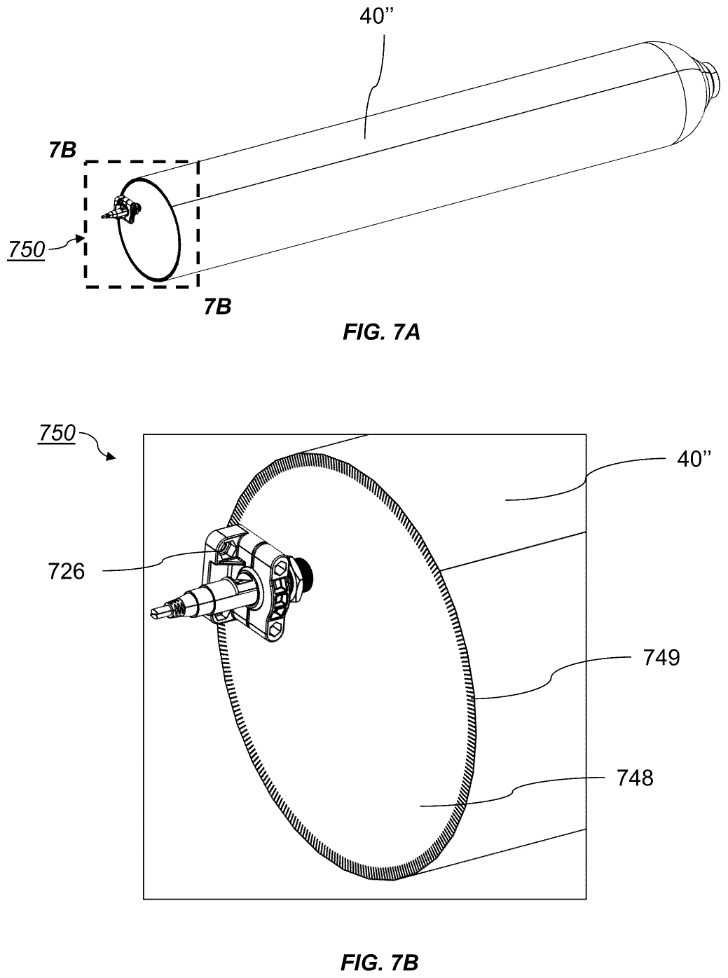

Turning to FIG. 7A, another example rotary encoder system 750 is illustrated in an exploded state with another example cylinder 40″, which is modified at its mounting end with respect to prior cylinders 40 of this disclosure. As further illustrated in FIG. 7B, which shows a close-up of section 7B-7B of FIG. 7A, modified cylinder 40″ here can include a locating encoder ring pattern 749 engraved or otherwise shaped in its base surface 748 at the base end of the cylinder 40″. In some aspects, pattern 749 can be scribed, laser etched, or otherwise mechanically formed (e.g. printed or adhered, among other methods) on the base surface 748 at the base end of the cylinder 40″. System 750 can include an optical encoder 726 configured to track the rotational motion of cylinder 40″ by reading position information of pattern 749. The optical encoder 726 is configured to detect the rotary position of the base end of the cylinder 40″ by tracking rotational motion of the cylinder 40″ by reading position information of the encoder ring pattern 749 during testing operations. In some aspects, encoder 726 is selectively positioned with previous system 300 in a position and orientation to measure the circumferential position of cylinder 40″ during testing. In some aspects, pattern 749 can be formed by being affixed to the cylinder (i.e. not engraved but adhered to base surface 748).

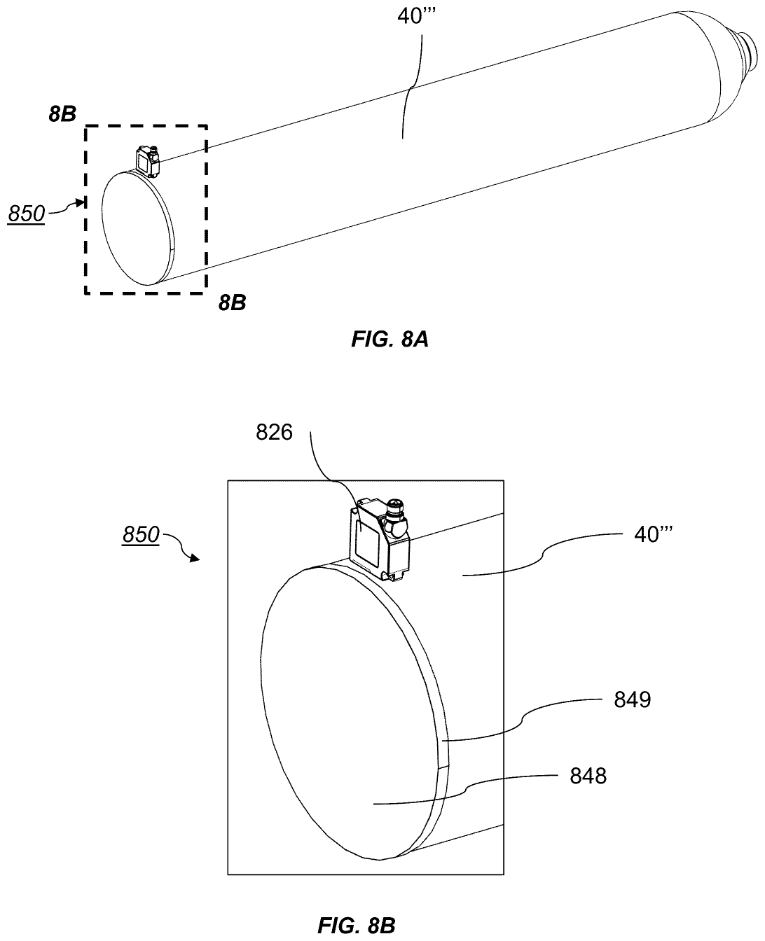

Turning to FIG. 8A, another example rotary encoder system 850 is illustrated in an exploded state with another example cylinder 40′″, which is modified at its mounting end with respect to prior cylinders 40 of this disclosure. As further illustrated in FIG. 8B, which shows a close-up of section 8B-8B of FIG. 8A, modified cylinder 40′″ here can include a locating encoder ring pattern 849 affixed or otherwise applied about its base surface 848. System 850 can include a spectrophotometer/color encoder 826 that is used to track the rotational position of the cylinder 40′″. In some aspects, pattern 849 can include a color gradient that is applied using a sticker of defined length, or otherwise mechanically introduced (e.g. printed, attached, or adhered, among other methods) on the base of cylinder 40′″. The color gradient may be used to measure the rotary position of the cylinder 40′″ during testing operations. In some aspects, the color sensing encoder 826 is positioned to measure the circumferential position of pattern 849 and therefore the circumferential position of cylinder 40′″ during testing.

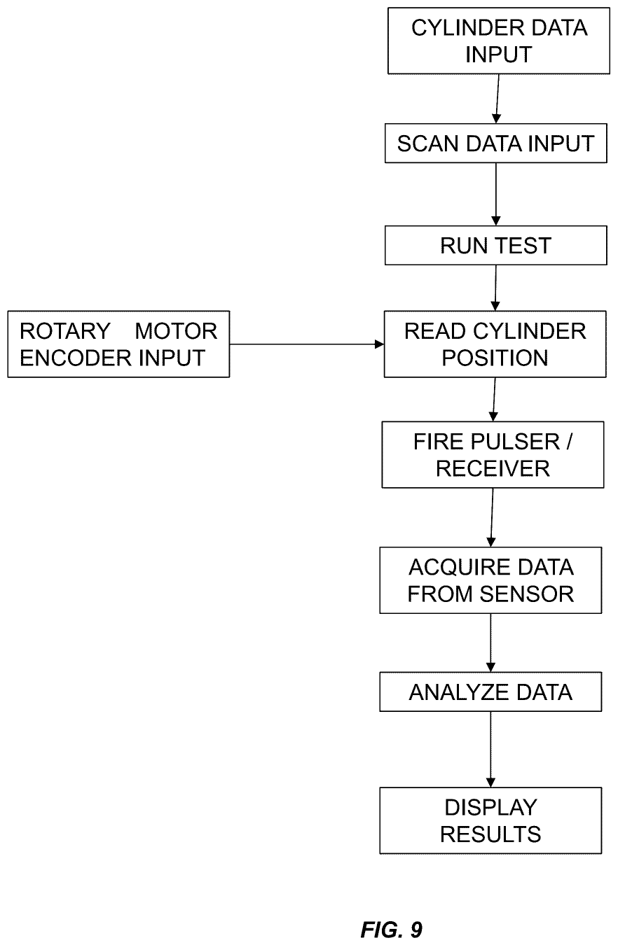

FIG. 9 shows the flow chart of operating an example rotary encoder system according to any example herein, including the examples of FIGS. 13-37. During the depicted operations, one or more computer systems can be used to control motion of the system 300 with any herein disclosed encoder system (e.g., systems 450, 550, 650, 750, 850 or any of the encoder systems of FIGS. 13-37) for data acquisition, and data analysis. In some aspects, motion control is performed by data input by the operator. Cylinder length, diameter, minimum wall thickness and material properties can be input and rotation speed, scanning resolution, scan start and stop positions, A/D converter rate, data acquisition window length, signal delay, and sensor offset angle are also input. Similar information may be provided for a tube in an implementation of FIGS. 13-37. After the scanning data is input, the operator can scan a cylinder (e.g., any of cylinders 40, 40′, 40″, 40′″, etc.) or a tube according to the implementations of FIGS. 13-37. The system then reads the rotational information of the respective cylinder and/or tube and fires the pulser/receiver. In some aspects, the system 300 with any herein disclosed encoder system acquires the data from the ultrasonic inspection which is then analyzed for thickness and defect information and the results are displayed.

The method may include arranging at least a portion of a cylinder in a measuring position relative to a plurality of rollers and an encoder system of a non-direct drive ultrasonic scanning system. The method may include spinning, by the plurality of rollers, the cylinder. The method may include moving an ultrasonic transducer into proximity with the cylinder. The method may include detecting, by the encoder system, a rotary position of a portion of the cylinder. The method may include synchronizing, based on the rotary position, rotational and translational motion of an ultrasonic transducer of the non-direct drive ultrasonic scanning system. The method may include determining, using the rotary position and signals from the ultrasonic transducer of the non-direct drive ultrasonic scanning system, whether a defect of the cylinder is present. The steps of the method may be varied, modified, or performed in a different order as desired. The steps of the method may include any of the features (including but not limited to encoder systems or cylinders) disclosed herein. The method may include detecting, by the ultrasonic transducer, a set of signals resulting from a set of ultrasonic pulses.

In examples, any of the systems disclosed herein may be portable.

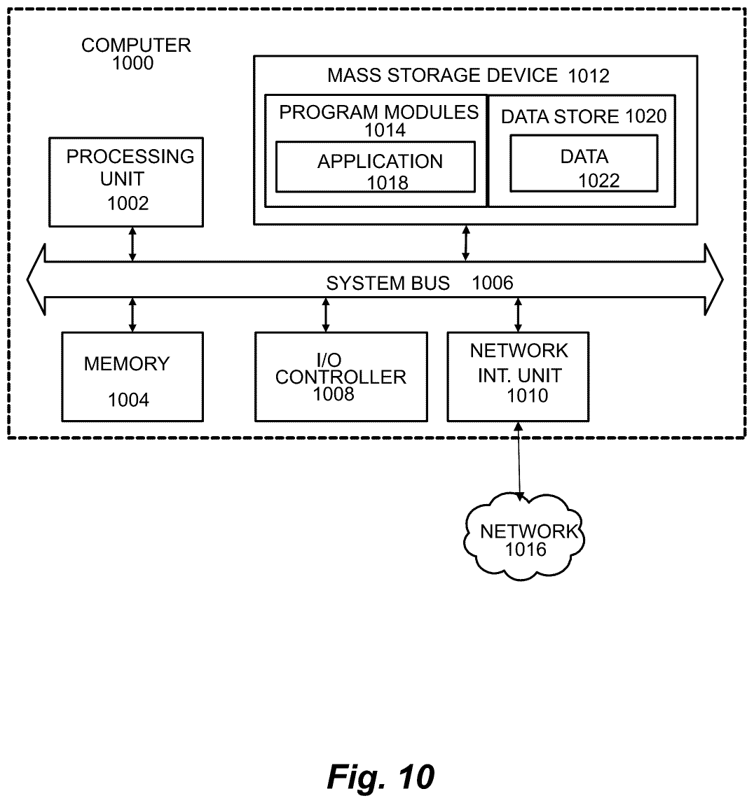

FIG. 10 is a computer architecture diagram showing a general computing system capable of implementing aspects of the present disclosure in accordance with one or more examples described herein, including any of the examples of FIGS. 13-37. In any of these example implementations, computer 1000 may be configured to perform one or more functions associated with examples of this disclosure. For example, the computer 1000 may be configured to perform operations in accordance with those examples shown in FIGS. 1 to 9 or FIGS. 13-37. It should be appreciated that the computer 1000 may be implemented within a single computing device or a computing system formed with multiple connected computing devices. The computer 1000 may be configured to perform various distributed computing tasks, in which processing and/or storage resources may be distributed among the multiple devices. A data acquisition and display computer and/or an operator console of the system shown in FIG. 10 may include one or more systems and components of the computer 1000.

As shown, the computer 1000 includes a processing unit 1002 (“CPU”), a system memory 1004, and a system bus 1006 that couples the memory 1004 to the CPU 1002. The computer 1000 further includes a mass storage device 1012 for storing program modules 1014. The program modules 1014 may be operable to analyze data from any herein disclosed components and/or control any related operations. The program modules 1014 may include an application 1018 for performing data acquisition and/or processing functions as described herein, for example to acquire and/or process any of the herein discussed data feeds. The computer 1000 can include a data store 1020 for storing data that may include data 1022 of data feeds from system components.

The mass storage device 1012 is connected to the CPU 1002 through a mass storage controller (not shown) connected to the bus 1006. The mass storage device 1012 and its associated computer-storage media provide non-volatile storage for the computer 1000. Although the description of computer-storage media contained herein refers to a mass storage device, such as a hard disk or CD-ROM drive, it should be appreciated by those skilled in the art that computer-storage media can be any available computer storage media that can be accessed by the computer 1000.

By way of example and not limitation, computer storage media (also referred to herein as “computer-readable storage medium” or “computer-readable storage media”) may include volatile and non-volatile, removable and non-removable media implemented in any method or technology for storage of information such as computer-storage instructions, data structures, program modules, or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 1000. “Computer storage media”, “computer-readable storage medium” or “computer-readable storage media”as described herein do not include transitory signals.

According to various examples, the computer 1000 may operate in a networked environment using connections to other local or remote computers through a network 1016 via a network interface unit 1010 connected to the bus 1006. The network interface unit 1010 may facilitate connection of the computing device inputs and outputs to one or more suitable networks and/or connections such as a local area network (LAN), a wide area network (WAN), the Internet, a cellular network, a radio frequency (RF) network, a Bluetooth-enabled network, a Wi-Fi enabled network, a satellite-based network, or other wired and/or wireless networks for communication with external devices and/or systems.

The computer 1000 may also include an input/output controller 1008 for receiving and processing input from any of a number of input devices. Input devices may include one or more of keyboards, mice, stylus, touchscreens, microphones, audio capturing devices, and image/video capturing devices. An end user may utilize the input devices to interact with a user interface, for example a graphical user interface, for managing various functions performed by the computer 1000. The bus 1006 may enable the processing unit 1002 to read code and/or data to/from the mass storage device 1012 or other computer-storage media.

The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer storage media may also represent secondary storage, whether implemented as hard drives or otherwise. Hard drive implementations may be characterized as solid state or may include rotating media storing magnetically-encoded information. The program modules 1014, which include the data feed application 1018, may include instructions that, when loaded into the processing unit 1002 and executed, cause the computer 1000 to provide functions associated with one or more examples illustrated in the figures of this disclosure. The program modules 1014 may also provide various tools or techniques by which the computer 1000 may participate within the overall systems or operating environments using the components, flows, and data structures discussed throughout this description.

In general, the program modules 1014 may, when loaded into the processing unit 1002 and executed, transform the processing unit 1002 and the overall computer 1000 from a general-purpose computing system into a special-purpose computing system. The processing unit 1002 may be constructed from any number of transistors or other discrete circuit elements, which may individually or collectively assume any number of states. More specifically, the processing unit 1002 may operate as a finite-state machine, in response to executable instructions contained within the program modules 1014. These computer-executable instructions may transform the processing unit 1002 by specifying how the processing unit 1002 transitions between states, thereby transforming the transistors or other discrete hardware elements constituting the processing unit 1002.

Encoding the program modules 1014 may also transform the physical structure of the computer-storage media. The specific transformation of physical structure may depend on various factors, in different implementations of this description. Examples of such factors may include but are not limited to the technology used to implement the computer-storage media, whether the computer storage media are characterized as primary or secondary storage, and the like. For example, if the computer storage media are implemented as semiconductor-based memory, the program modules 1014 may transform the physical state of the semiconductor memory, when the software is encoded therein. For example, the program modules 1014 may transform the state of transistors, capacitors, or other discrete circuit elements constituting the semiconductor memory.

As another example, the computer storage media may be implemented using magnetic or optical technology. In such implementations, the program modules 1014 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

According to certain examples, the above-described data feeds may be stored in databases such as database servers that store master data, event related data, response plan data, telemetry information, and mission data as well as logging and trace information. The databases may also provide an API and/or API access (e.g., for open source) to the web server for data interchange based on JSON specifications. In some examples, the database may also directly interact with systems and monitoring devices to identify, determine, and control response operations. According to certain examples, the database servers may be optimally designed for storing large amounts of data, responding quickly to incoming requests, having a high availability and historizing master data.

FIG. 11 illustrates a configuration of a tube 1100 that may be utilized in examples herein. The tube 1100 may include a wall 1102 that surrounds an interior channel 1104 of the tube 1100. The interior channel 1104 may comprise an opening that extends for the length of the tube 1100. The tube 1100 may have a first end portion 1106 or base end portion having a first opening 1108 or base end opening. The tube 1100 may have an opposite second end portion 1110 or distal end portion having a second opening 1112 (marked in FIG. 12) or distal end opening. The interior channel 1104 may comprise the bore of the tube 1100. FIG. 12 illustrates a side cross sectional view of the tube 1100.

The tube 1100 may include an interior surface 1114. The interior surface 1114 may face towards the interior channel 1104 and may face opposite an exterior surface 1116 of the tube 1100. The interior surface 1114 may have a shape that defines the shape of the interior channel 1104.

The tube 1100 may have a variety of lengths and/or diameters as desired. The tube 1100 may have a variety of shapes as desired. As represented in FIG. 11, the tube 1100 may have a circular outer profile, although other shapes may be utilized as desired. The tube 1100 may have a circular profile of the interior channel 1104, although other shapes may be utilized as desired. The tube 1100 may comprise a rigid tube 1100 in examples, although tubes having flexibility may be utilized as desired.

The tube 1100 may be utilized in a variety of implementations. The tube 1100, for example, may be utilized for conveyance through the interior channel 1104. The tube 1100 may be utilized to convey materials through the interior channel 1104. Such materials may comprise solid objects or fluids (e.g., liquid or gas) as desired. The tube 1100 may be utilized to convey materials from the first end portion 1106 to the second end portion 1110 as desired. The tube 1100 may be utilized for industrial purposes, or may be utilized in military or weapon applications as desired, among other applications. For example, the tube 1100 may be utilized as a torpedo tube for a submarine, a cannon (e.g., for a tank or navel vessel), or as a gun barrel in implementations. Other uses for the tube 1100 may be utilized.

It may be desirable to detect defects in the tube 1100 through similar forms of testing as disclosed herein. For example, ultrasonic testing methods or other forms of testing methods as disclosed herein may be utilized as desired. The testing methods may include non-direct drivetrains as disclosed herein (e.g., as disclosed in regard to FIG. 3), or other forms of testing methods as desired. An encoder system may be utilized for detecting a rotary position of a portion of the tube 1100 utilizing methods disclosed herein. However, a configuration of the encoder system may be provided for testing an object having a configuration of a tube. FIGS. 13-37 illustrate examples of encoder systems that may be utilized for testing a tube. The examples of any of FIGS. 13-37 may be utilized with the ultrasonic scanning system 300 of FIG. 3 and the methods and features disclosed herein.

FIG. 13, for example, illustrates an example rotary encoder system 1120. The encoder system 1120 is configured to detect a rotary position of a portion of the tube 1100. The system 1120 may include a rotary encoder 1122 and an engagement assembly 1124. A rotating shaft 1126 may extend from the encoder 1122 through a rotary union housing 1128 to the engagement assembly 1124 in examples. The engagement assembly 1124 may be configured to engage with the tube 1100. The engagement assembly 1124 may be configured to engage with the interior surface 1114 of the tube 1100 in examples. The engagement assembly 1124 may apply a radial force for engagement with the interior surface 1114 of the tube 1100. At least a portion of the engagement assembly 1124 may insert into the interior channel 1104 of the tube 1100 in examples, to engage with the interior surface 1114 of the tube 1100. Other configurations may be utilized as desired.

The engagement assembly 1124 may include one or more arm assemblies (e.g., arm assemblies 1130a-c) in examples. The one or more arm assemblies 1130a-c may be configured for engagement with the tube 1100. Each arm assembly 1130a-c may be configured to apply a radially outward force to the tube 1100 to engage with the tube 1100. Each arm assembly 1130a-c may be configured to move radially outward for engagement with the tube 1100. Each arm assembly 1130a-c may include a respective friction surface 1132a-c for applying friction to the tube 1100 to engage with the tube 1100. FIG. 14 illustrates a rear perspective view of the rotary encoder system 1120.

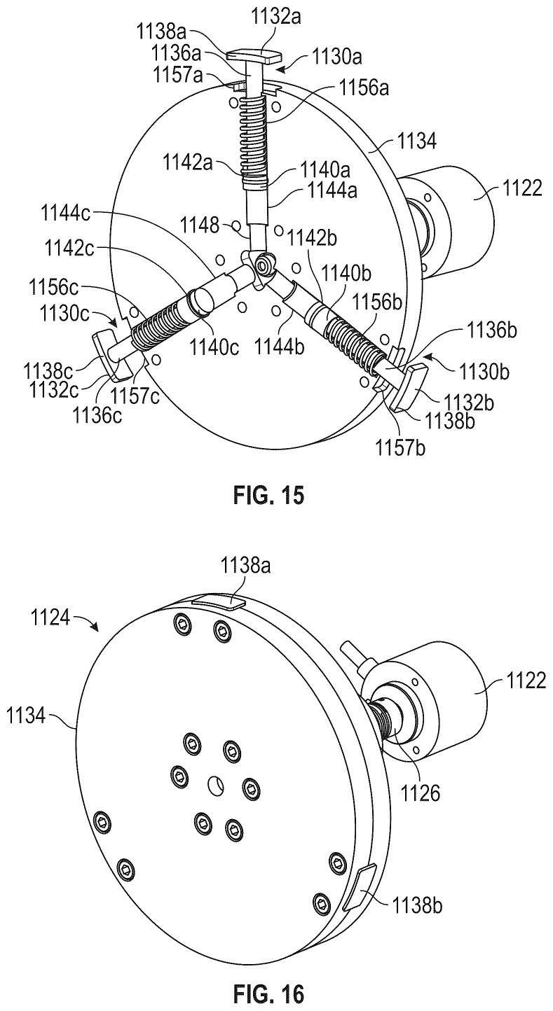

FIG. 15 illustrates a perspective view of the engagement assembly 1124 with a portion of the base 1134 having been removed from view. Each arm assembly 1130a-c may include a respective arm 1136a-c and a respective head portion 1138a-c positioned at a radially outward end of the respective arm 1136a-c. A radially inward end of the respective arm 1136a-c may comprise a piston head 1140a-c that may include a respective sealing device 1142a-c (e.g., an o-ring or other form of sealing device). Each arm assembly 1130a-c may be configured to slide radially outward and/or inward within a respective channel 1144a-c of the base 1134.

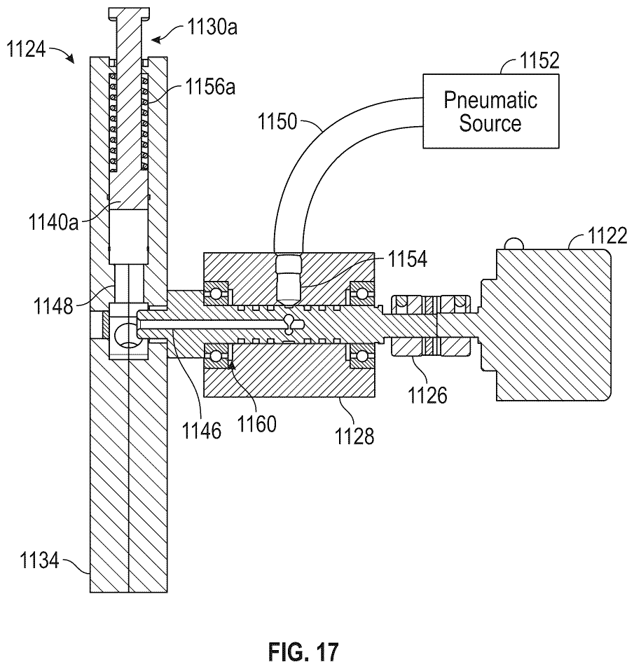

In examples, the engagement assembly 1124 may include a pneumatic system. The pneumatic system may be configured to produce an engagement force with the tube 1100 to engage with the tube 1100. The force may be a radially outward force. For example, the pneumatic system may be configured to move the one or more arm assemblies 1130a-c radially outward to engage with the tube 1100. Referring to the side cross sectional view of FIG. 17, the pneumatic system may include one or more pneumatic conduits 1146, 1148, 1150 and may include a pneumatic source 1152. The pneumatic system may produce a pressure (e.g., a positive pneumatic pressure) that may be applied to drive the one or more arm assemblies 1130a-c radially outward for friction with the tube 1100.

The pneumatic conduit 1146 may extend through the rotary union housing 1128 and may be in pneumatic communication with the pneumatic conduit 1148. The pneumatic conduit 1148 may direct the pneumatic pressure to the respective piston head 1140a-c to drive the arm assemblies 1130a-c radially outward. The arm assemblies 1130a-c may comprise pneumatic actuated plungers. The pneumatic conduit 1148 may comprise a manifold that directs the pneumatic pressure to each of the respective piston heads 1140a-c. The pneumatic conduit 1148 may be positioned within the base 1134. The pneumatic conduit 1148 may provide pressure into the respective channel 1144a-c of the base 1134. The pneumatic conduit 1146 may be in pneumatic communication with the pneumatic port 1154 that may be positioned on the rotary union housing 1128. The pneumatic connection between the conduit 1146 and the port 1154 may be rotational, in that the conduit 1146 may rotate yet remain in pneumatic communication with the port 1154. The pneumatic port 1154 may be connected with the conduit 1150 that may be in pneumatic communication with the pneumatic source 1152. The pneumatic source 1152 may comprise a source of pneumatic pressure and may comprise a pneumatic pump or a reservoir of compressed gas or another source of pneumatic pressure.

In operation, the pneumatic source 1152 may apply the pneumatic pressure through the respective conduits 1150, 1146, 1148 to drive the one or more arm assemblies 1130a-c radially outward for friction with the tube 1100. The arm assemblies 1130a-c may extend until pressing upon the interior surface of the tube 1100. In examples, one or more springs 1156a-c (marked in FIG. 15) may be utilized to retract the one or more arm assemblies 1130a-c radially inward at a desired time (in a retracted configuration as represented in FIG. 16). In examples, the springs 1156a-c may be excluded and a pneumatic vacuum pressure (e.g., a negative pressure) may be utilized to retract the one or more arm assemblies 1130a-c radially inward. Referring to FIG. 15, a respective support surface 1157a-c may contact the respective head portion 1138a-c upon retraction to impede further retraction in a radially inward direction.

Referring to FIG. 13, the engagement assembly 1124 may include a base 1134, a plate, or a manifold housing that may support the one or more arm assemblies 1130a-c. The arm assemblies 1130a-c may extend radially outward from the base 1134. The base 1134 may include the pneumatic conduit 1148 and the respective channel 1144a-c of the base 1134. The base 1134 may include multiple plate portions that may be held together to secure the interior components of the base 1134 (e.g., a plate portion is shown excluded from view in FIG. 15). The base 1134 may have a circular outer profile or may have another configuration as desired. The circular outer profile may allow the base 1134 to fit within the interior channel 1104 of the tube 1100 in a testing procedure. Other configurations may be utilized as desired.

The engagement assembly 1124 may be configured to rotate with the tube 1100 upon being engaged with the tube 1100. For example, referring to FIG. 17, the encoder system 1120 may include a rotational bearing 1160 that allows at least a portion of the engagement assembly 1124 to rotate with the tube 1100. The rotary union housing 1128, for example, may remain rotationally static during a testing procedure, with the base 1134, and rotating shaft 1126 rotating with the tube 1100. Other configurations may be utilized as desired.

The rotary encoder 1122 may be configured to detect the rotary position of the engagement assembly 1124 to detect the rotary position of the tube 1100. The rotary encoder 1122, for example, may detect the rotary position of the rotating shaft 1126 to detect the rotary position of the engagement assembly 1124.

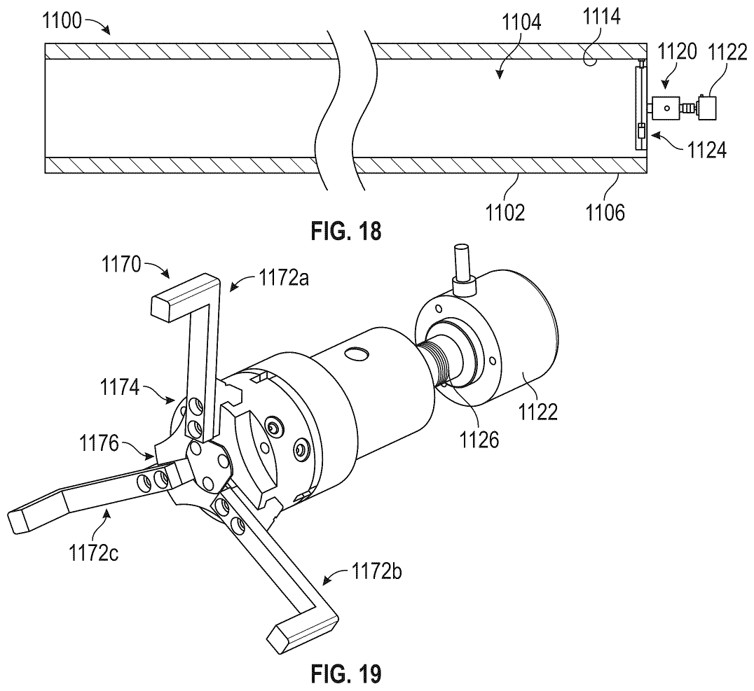

FIG. 18 illustrates an exemplary use of the encoder system 1120. The encoder system 1120 may be inserted into the interior channel 1104 (e.g., at a first end portion 1106 or base end portion) of the tube 1100. The encoder system 1120 may be positioned within a mount that can attach directly to aspects of prior described system 300 (e.g., housing mounted in a wall of a fluid tank). The one or more arm assemblies 1130a-c of the engagement assembly 1124 may extend radially outward to engage with the interior surface 1114 of the tube 1100. The tube 1100 may be rotated with an assembly as represented in FIG. 3 for example. The tube 1100 may be positioned on one or more rollers 315 as represented in FIG. 3. The engagement assembly 1124 may rotate with the tube 1100 and the rotary encoder 1122 may detect the rotary position of the tube 1100.

In some aspects, the friction force between the engagement assembly 1124 and tube 1100 can be sufficiently larger than any frictional drag capable of being developed in the rotary encoder 1122 during testing operations (e.g., frictional drag developed in the rotary encoder 1122 by rotation caused by the rotating shaft 1126 during testing operations). The rotary encoder system 1120 may be used with any non-direct drive system, such as system 300, and with ferrous or non-ferrous tubes 1100.

The rotary position of the tube 1100 is determined by the output of encoder 1122. Output of rotary encoder 1122 is read according to method disclosed herein (e.g., by a counter on a trigger board and used to trigger the ultrasound pulser/receiver module 14). Based on the detected rotary position, the system can synchronize any detected slippage based on the rotary position with rotational and translational motion of its ultrasonic transducer. The ultrasonic transducer may comprise an adjustable receiving/transmitting transducer positioned to mount proximal to the tube 1100. In some aspects, at specific intervals measured by the rotary encoder, a high voltage electrical pulse from a pulser/receiver module can be sent to an ultrasonic sensor of the system. This creates an ultrasonic pulse that propagates and into a wall of tube 1100. The pulse echoes back from the wall of tube 1100 and is detected by the ultrasonic sensor. In some aspects, the ultrasonic sensor can send a signal to pulser/receiver module, which amplifies and filters the received signal and sends a trigger pulse to an A/D converter. The signal is then digitized by the A/D converter, and then stored in an electronic format for analysis by aspects of a connected computer system. All of these operations can take place in the non-direct drive system 300 while also accounting for slippage.

Other configurations of encoder systems may be utilized in examples. FIG. 19, for example, illustrates a variation of the encoder system 1120 that includes the features of the encoder system 1120 unless stated otherwise. The encoder system 1170, for example, includes one or more arm assemblies 1172a-c each configured to move radially outward for engagement with an interior surface 1114 of a tube 1100 in a similar manner as with the arm assemblies 1130a-c. The engagement assembly 1174 may include a pneumatic system configured to produce an engagement force with the tube to engage with the tube 1100. However, the pneumatic system in a configuration represented in FIG. 19 may apply a force to a mechanical interface 1176 to move the one or more arm assemblies 1172a-c radially outward to engage with the tube 1100. The pneumatic system may comprise a pneumatic gripper. The mechanical interface 1176 may be configured to drive the one or more arm assemblies 1172a-c radially outward upon a pneumatic pressure being applied, and the reduction of the pneumatic pressure or a pneumatic vacuum force may cause the one or more arm assemblies 1172a-c to retract radially inward at a desired time. In examples, the one or more arm assemblies 1172a-c may be removable and able to be interchanged for other arm assemblies having different lengths. Such a configuration may account for a variety of different size of diameters of tubes 1100. The use and testing performed by the encoder system 1170 may otherwise be the same as with the encoder system 1120.

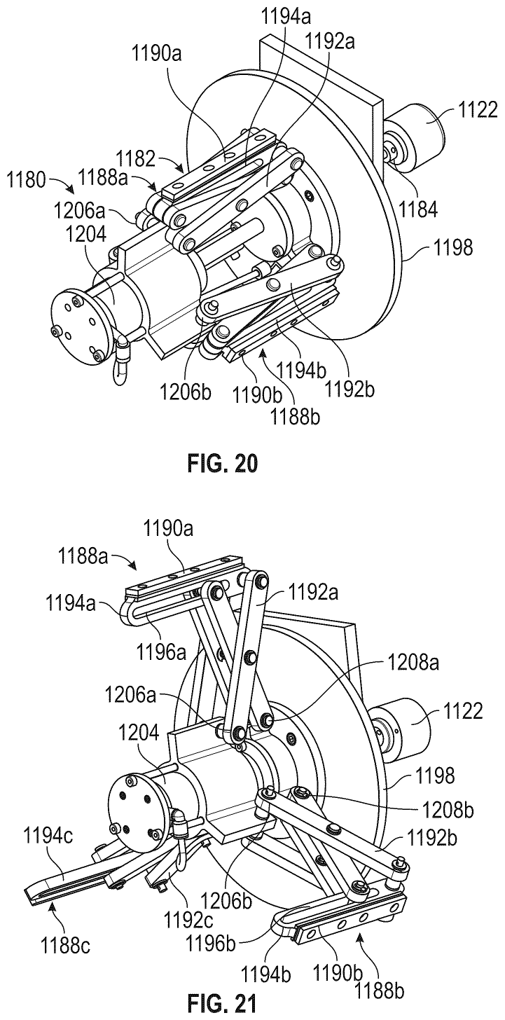

Other variations of encoder systems may be utilized in examples. FIG. 20, for example, illustrates a variation that may include the features of the encoder system 1120 and operate in a similar manner as the encoder system 1120 unless stated otherwise. The rotary encoder system 1180 may include the rotary encoder 1122 and may include an engagement assembly 1182. A rotating shaft 1184 may extend from the encoder 1122 through a rotary union housing 1186 to the engagement assembly 1182 in examples. The engagement assembly 1182 may be configured to engage with the tube 1100. The engagement assembly 1182 may be configured to engage with the interior surface 1114 of the tube 1100 in examples. The engagement assembly 1182 may apply a radial force for engagement with the interior surface 1114 of the tube 1100. At least a portion of the engagement assembly 1182 may insert into the interior channel 1104 of the tube 1100 in examples, to engage with the interior surface 1114 of the tube 1100. Other configurations may be utilized as desired.

The engagement assembly 1182 may include one or more arm assemblies (e.g., arm assemblies 1188a-c) in examples. The one or more arm assemblies 1188a-c may be configured for engagement with the tube 1100. Each arm assembly 1188a-c may be configured to apply a radially outward force to the tube 1100 to engage with the tube 1100. Each arm assembly 1188a-c may be configured to move radially outward for engagement with the tube 1100. Each arm assembly 1188a-c may include a respective friction surface 1190a-c for applying friction to the tube 1100 to engage with the tube 1100.

Each arm assembly 1188a-c may include a respective lever arm linkage 1192a-c. Each lever arm linkage 1192a-c may be configured to extend radially outward towards an interior surface of the tube 1100. Each lever arm linkage 1192a-c may comprise a scissor linkage or another form of linkage as desired. The linked supports may be in an “X” pattern or another pattern as desired. Each friction surface 1190a-c may be positioned on a respective one of the lever arm linkages 1192a-c. Each lever arm linkage 1192a-c may include a respective head portion 1194a-c upon which the respective friction surface 1190a-c may be positioned. The friction surfaces 1190a-c may comprise a pad (e.g., an elastomer pad, such as a rubber pad or other form of elastomer) or may have another configuration as desired. Each head portion 1194a-c may include a respective slot 1196a-c for a portion of the lever arm linkage 1192a-c to slide along upon expansion or retraction of the respective lever arm linkage 1192a-c. Other configurations may be utilized in examples.

The respective lever arm linkage 1192a-c may be configured to radially expand or contract upon axial movement of the respective lever arm linkage 1192a-c. An axial retraction towards a base 1198 of the engagement assembly 1182 may produce a radially outward expansion of the respective lever arm linkage 1192a-c and an opposite axial advancement away from the base 1198 may produce a radially inward retraction of the respective lever arm linkage 1192a-c. Other configurations may be utilized in examples.

In examples, the engagement assembly 1182 may include a pneumatic system. The pneumatic system may be configured to produce an engagement force with the tube 1100 to engage with the tube 1100. The force may be a radially outward force. For example, the pneumatic system may be configured to move the one or more arm assemblies 1188a-c radially outward to engage with the tube 1100. Referring to the side cross sectional view of FIG. 23, the pneumatic system may include one or more pneumatic conduits 1200, 1202 and may include a pneumatic actuator 1204 in examples. The pneumatic system may further include a pneumatic conduit 1150 and a pneumatic source 1152 as represented in FIG. 17 for example. The pneumatic system may produce a pressure that may be applied to drive the one or more arm assemblies 1188a-c radially outward for friction with the tube 1100.

The pneumatic conduit 1200 may extend through the rotary union housing 1186 and may be in pneumatic communication with the pneumatic conduit 1202. The pneumatic conduit 1202 may comprise a hose extending to the pneumatic actuator 1204. The pneumatic conduit 1200 may be in pneumatic communication with the pneumatic port 1201 that may be positioned on the rotary union housing 1186. The pneumatic connection between the conduit 1200 and the port 1201 may be rotational, in that the conduit 1200 may rotate yet remain in pneumatic communication with the port 1201. The pneumatic port 1201 may be connected with a conduit 1150 and a pneumatic source 1152 as described in regard to the port 1154.

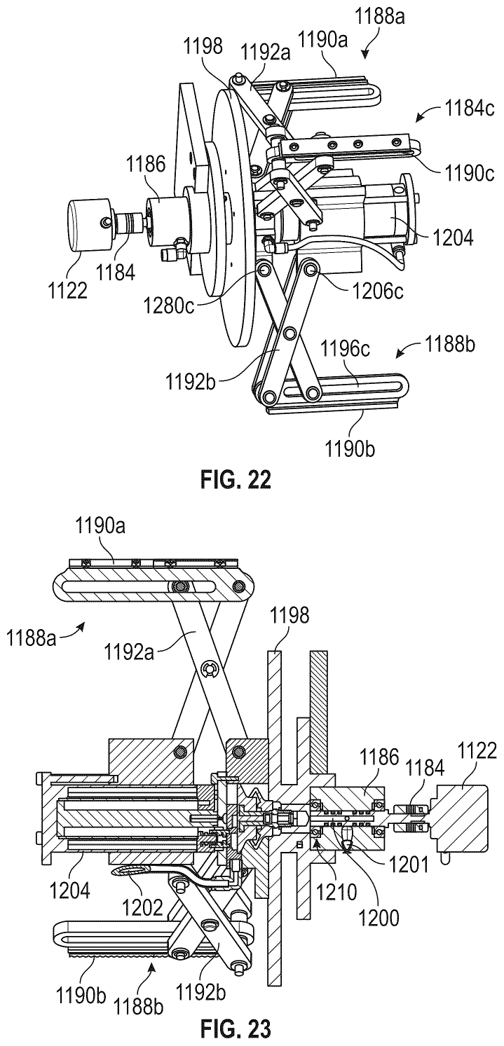

In operation, the pneumatic source 1152 may apply the pneumatic pressure to the pneumatic actuator 1204. The pneumatic actuator 1204 may comprise a piston and cylinder that may expand or contract due to the pneumatic pressure (e.g., an application of compressed air or another form of pressure). In operation, each lever arm linkage 1192a-c may include a respective first portion 1206a-c (marked in FIGS. 20 and 22) that is coupled to the pneumatic actuator 1204. Each lever arm linkage 1192a-c may include a respective second portion 1208a-c (marked in FIGS. 20 and 22) that may be coupled to the base 1198. The pneumatic actuator 1204 may be configured to move towards the base 1198 to expand each lever arm linkage 1192a-c radially outward. Each lever arm linkage 1192a-c may extend radially outward until contact with the interior surface of the tube 1100. Similarly, the pneumatic actuator 1204 may be configured to move away from the base 1198 to retract each lever arm linkage 1192a-c radially inward.

Referring to FIG. 20, the engagement assembly 1182 may include a base 1198 or a plate that may support the one or more arm assemblies 1188a-c. The base 1198 may have a circular outer profile or may have another configuration as desired. The circular outer profile may allow the base 1198 to fit within the interior channel 1104 of the tube 1100 in a testing procedure. Other configurations may be utilized as desired.

The engagement assembly 1182 may be configured to rotate with the tube 1100 upon being engaged with the tube 1100. For example, referring to FIG. 23, the encoder system 1180 may include a rotational bearing 1210 that allows at least a portion of the engagement assembly 1182 to rotate with the tube 1100. The rotary union housing 1186, for example, may remain rotationally static during a testing procedure, with the base 1198, and rotating shaft 1184 rotating with the tube 1100. Other configurations may be utilized as desired.

The rotary encoder 1122 may be configured to detect the rotary position of the engagement assembly 1182 to detect the rotary position of the tube 1100 as disclosed herein. Methods as disclosed regarding the rotary encoder system 1120 may be utilized for testing the tube 1100.

In examples, the arm assemblies 1130a-c may include at least three of the arm assemblies 1130a-c and accordingly at least three of the lever arm linkages 1192a-c spaced circumferentially from each other. Other configurations may be utilized in examples (e.g., a greater or lesser number of arm assemblies or lever arm linkages as desired).

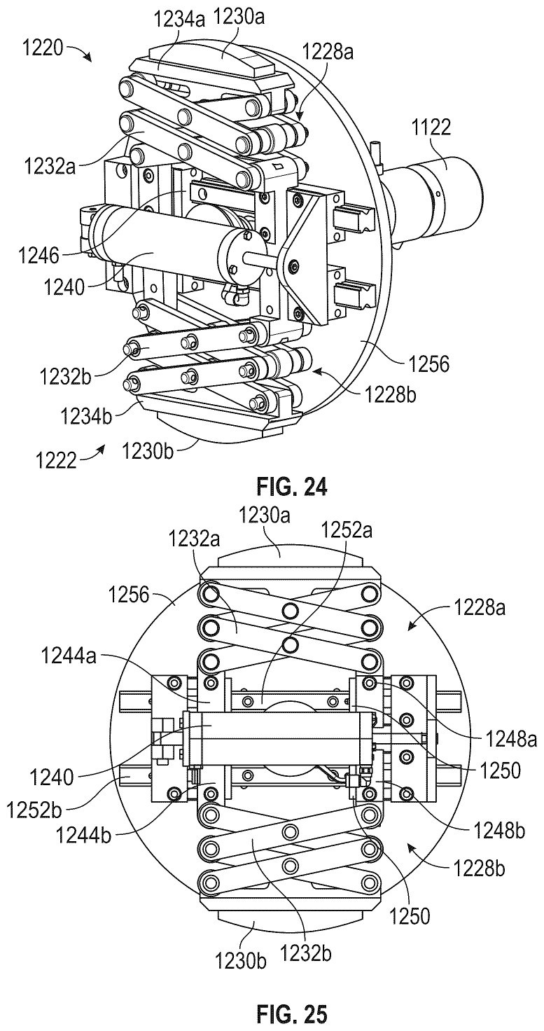

Other variations may be utilized. FIG. 24, for example, illustrates a variation that may include the features of the encoder system 1120 and operate in a similar manner as the encoder system 1120 unless stated otherwise. The rotary encoder system 1220 may include the rotary encoder 1122 and may include an engagement assembly 1222. A rotating shaft 1224 may extend from the encoder 1122 through a rotary union housing 1226 to the engagement assembly 1222 in examples. The engagement assembly 1222 may be configured to engage with the tube 1100. The engagement assembly 1222 may be configured to engage with the interior surface 1114 of the tube 1100 in examples. The engagement assembly 1222 may apply a radial force for engagement with the interior surface 1114 of the tube 1100. At least a portion of the engagement assembly 1222 may insert into the interior channel 1104 of the tube 1100 in examples, to engage with the interior surface 1114 of the tube 1100. Other configurations may be utilized as desired.

The engagement assembly 1222 may include one or more arm assemblies (e.g., arm assemblies 1228a, b) in examples. The one or more arm assemblies 1228a, b may be configured for engagement with the tube 1100. Each arm assembly 1228a, b may be configured to apply a radially outward force to the tube 1100 to engage with the tube 1100. Each arm assembly 1228a, b may be configured to move radially outward for engagement with the tube 1100. Each arm assembly 1228a, b may include a respective friction surface 1230a, b for applying friction to the tube 1100 to engage with the tube 1100. The friction surfaces 1230a, b may comprise a pad (e.g., an elastomer pad, such as a rubber pad or other form of elastomer) or may have another configuration as desired.

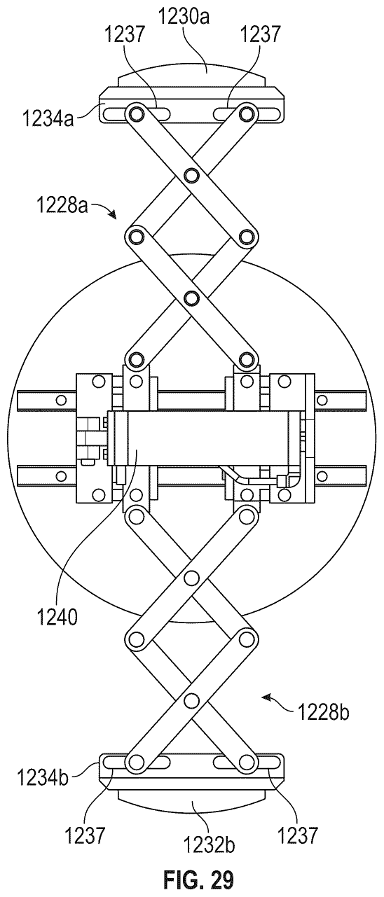

Each arm assembly 1228a, b may include a respective lever arm linkage 1232a, b. Each lever arm linkage 1232a, b may be configured to extend radially outward towards an interior surface of the tube 1100. Each lever arm linkage 1232a, b may comprise a scissor linkage or another form of linkage as desired. The linked supports may be in an “X” pattern or another pattern as desired. Each friction surface 1230a, b may be positioned on a respective one of the lever arm linkages 1232a, b. Each lever arm linkage 1232a, b may include a respective head portion 1234a, b upon which the respective friction surface 1230a, b may be positioned. Each head portion 1234a, b may include one or more respective slots 1237 (marked in FIG. 29) for a portion of the lever arm linkage 1232a, b to slide along upon expansion or retraction of the respective lever arm linkage 1232a, b. Other configurations may be utilized in examples.

The respective lever arm linkage 1232a, b may be configured to respectively radially expand or contract upon movement of the respective lever arm linkage 1232a, b transverse to the axial dimension. Other configurations may be utilized in examples.

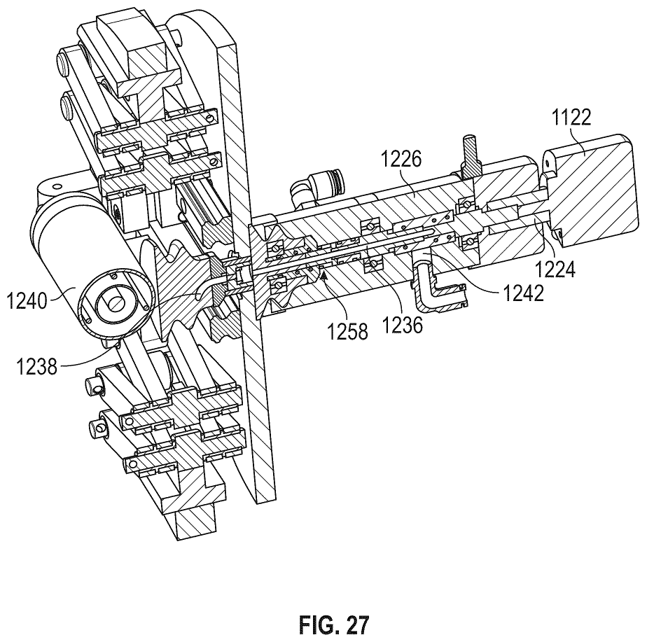

In examples, the engagement assembly 1222 may include a pneumatic system. The pneumatic system may be configured to produce an engagement force with the tube 1100 to engage with the tube 1100. The force may be a radially outward force. For example, the pneumatic system may be configured to move the one or more arm assemblies 1228a, b radially outward to engage with the tube 1100. Referring to the perspective cross sectional view of FIG. 27, the pneumatic system may include one or more pneumatic conduits 1236, 1238 and may include a pneumatic actuator 1240 in examples. The pneumatic system may further include a pneumatic conduit 1150 and a pneumatic source 1152 as represented in FIG. 17 for example. The pneumatic system may produce a pressure that may be applied to drive the one or more arm assemblies 1228a, b radially outward for friction with the tube 1100.

The pneumatic conduit 1236 may extend through the rotary union housing 1226 and may be in pneumatic communication with the pneumatic conduit 1238. The pneumatic conduit 1238 may comprise a hose extending to the pneumatic actuator 1240. The pneumatic conduit 1236 may be in pneumatic communication with the pneumatic port 1242 that may be positioned on the rotary union housing 1226. The pneumatic connection between the conduit 1236 and the port 1242 may be rotational, in that the conduit 1236 may rotate yet remain in pneumatic communication with the port 1242. The pneumatic port 1242 may be connected with a conduit 1150 and a pneumatic source 1152 as described in regard to the port 1154.

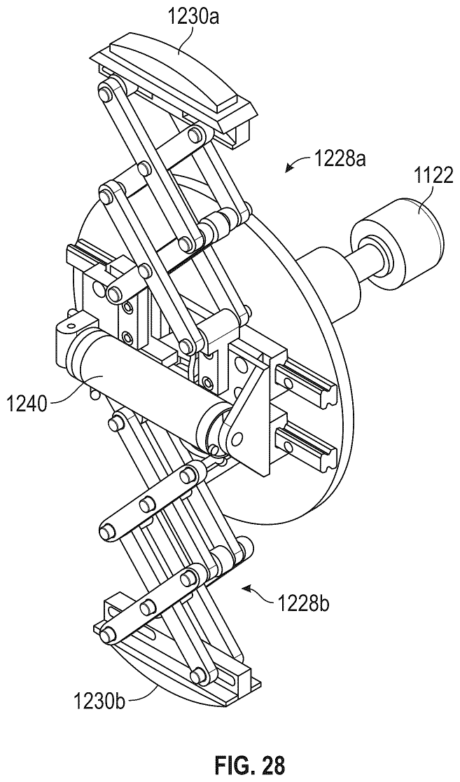

In operation, the pneumatic source 1152 may apply the pneumatic pressure to the pneumatic actuator 1240. The pneumatic actuator 1240 may comprise a piston and cylinder that may expand or contract due to the pneumatic pressure (e.g., an application of compressed air or another form of pressure). In operation, each lever arm linkage 1232a, b may include a respective first portion 1244a, b (marked in FIG. 25) that is coupled to one or more first sliders 1246 (marked in FIG. 24). Each lever arm linkage 1232a, b may include a respective second portion 1248a, b (marked in FIG. 25) that is coupled to one or more second sliders 1250. The sliders 1246, 1250 may be slidable by the pneumatic actuator 1240 in the direction that is transverse to the axial dimension (e.g., perpendicular to the axial dimension). Each slider 1246, 1250 may slide along one or more rails 1252a, b. As such, each lever arm linkage 1232a, b is configured to slide along at least one rail 1252a, b to extend radially outward towards an interior surface of the tube 1100. FIG. 24 27 illustrate the lever arm linkages 1232a, b in a contracted position and FIGS. 28 and 29 illustrate the lever arm linkages 1232a, b in an expanded position. The lever arm linkages 1232a, b may expand until contact with the interior surface of the tube.

In examples, two of the lever arm linkages 1232a, b may be utilized, each configured to expand in opposite directions from each other. Other configurations may be utilized in examples (e.g., a greater or lesser number of arm assemblies or lever arm linkages as desired). Other configurations may be utilized as desired.

Referring to FIG. 24, the engagement assembly 1222 may include a base 1256 or a plate that may support the one or more arm assemblies 1228a, b. The base 1256 may have a circular outer profile or may have another configuration as desired. The circular outer profile may allow the base 1256 to fit within the interior channel 1104 of the tube 1100 in a testing procedure. Other configurations may be utilized as desired.

The engagement assembly 1222 may be configured to rotate with the tube 1100 upon being engaged with the tube 1100. For example, referring to FIG. 27, the encoder system 1220 may include a rotational bearing 1258 that allows at least a portion of the engagement assembly 1222 to rotate with the tube 1100. The rotary union housing 1226, for example, may remain rotationally static during a testing procedure, with the base 1256, and rotating shaft 1224 rotating with the tube 1100. Other configurations may be utilized as desired.

The rotary encoder 1122 may be configured to detect the rotary position of the engagement assembly 1222 to detect the rotary position of the tube 1100 as disclosed herein. Methods as disclosed regarding the rotary encoder system 1120 may be utilized for testing the tube 1100.

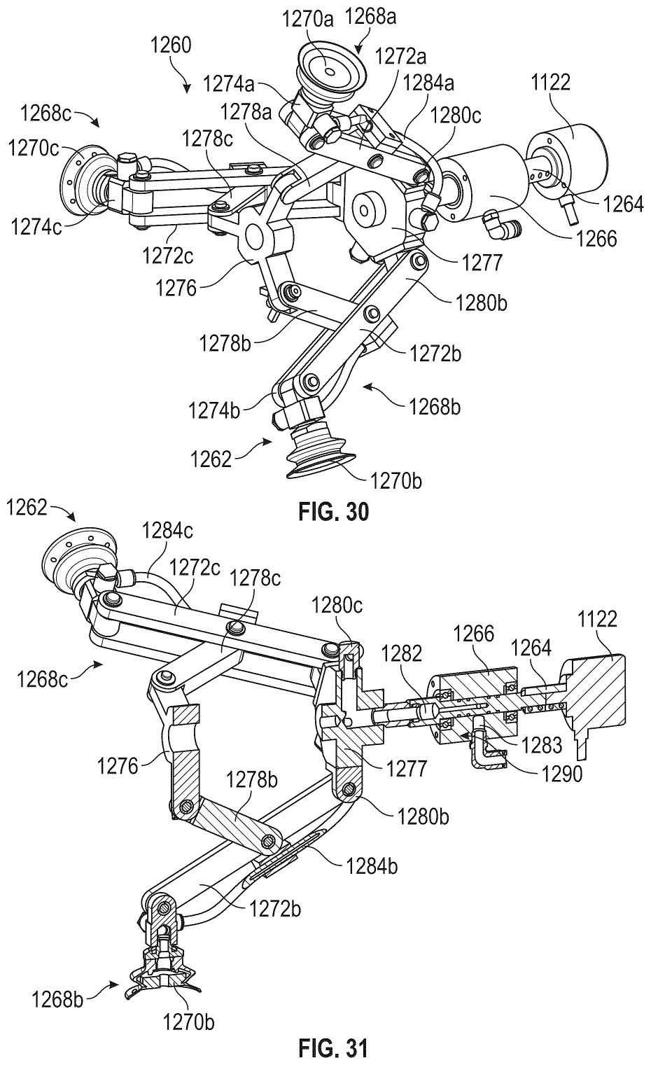

Other variations of encoder systems may be utilized in examples. FIG. 30, for example, illustrates a variation that may include the features of the encoder system 1120 and operate in a similar manner as the encoder system 1120 unless stated otherwise. The rotary encoder system 1260 may include the rotary encoder 1122 and may include an engagement assembly 1262. A rotating shaft 1264 may extend from the encoder 1122 through a rotary union housing 1266 to the engagement assembly 1262 in examples. The engagement assembly 1262 may be configured to engage with the tube 1100. The engagement assembly 1262 may be configured to engage with the interior surface 1114 of the tube 1100 in examples. The engagement assembly 1262 may apply a radial force (e.g., a radial suction force) for engagement with the interior surface 1114 of the tube 1100. At least a portion of the engagement assembly 1262 may insert into the interior channel 1104 of the tube 1100 in examples, to engage with the interior surface 1114 of the tube 1100. Other configurations may be utilized as desired.

The engagement assembly 1262 may include one or more arm assemblies (e.g., arm assemblies 1268a-c) in examples. The one or more arm assemblies 1268a-c may be configured for engagement with the tube 1100. Each arm assembly 1268a-c may be configured to move radially outward for engagement with the tube 1100. Each arm assembly 1268a-c may include a respective suction device 1270a-c for applying suction to the tube 1100 to engage with the tube 1100.

Each arm assembly 1268a-c may include a respective lever arm linkage 1272a-c. Each lever arm linkage 1272a-c may be configured to extend radially outward towards an interior surface of the tube 1100. Each lever arm linkage 1272a-c may comprise a scissor linkage or another form of linkage as desired. Each suction device 1270a-c may be positioned on a respective one of the lever arm linkages 1272a-c. Each lever arm linkage 1272a-c may include a respective head portion 1274a-c upon which the respective suction device 1270a-c may be positioned. The suction devices 1270a-c may comprise vacuum sealing cups as desired. Other configurations may be utilized in examples.

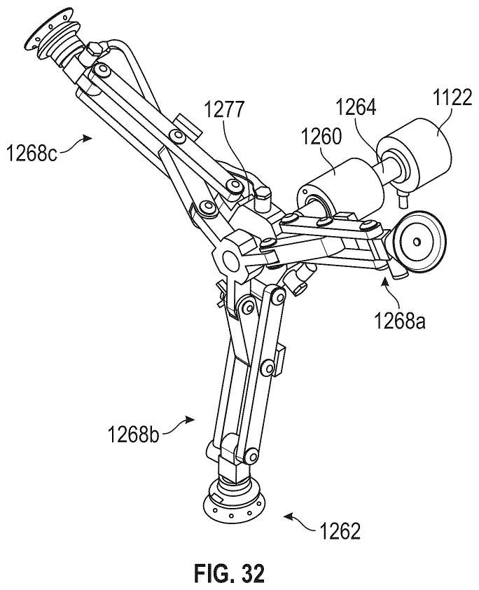

The respective lever arm linkage 1272a-c may be configured to respectively radially expand or contract upon axial movement of a central linkage support 1276. An axial retraction of the central linkage support 1276 towards a base 1277 of the engagement assembly 1262 may produce a radially outward expansion of the respective lever arm linkage 1272a-c and an axial advancement away from the base 1277 may produce a radially inward retraction of the respective lever arm linkage 1272a-c. The central linkage support 1276 may have a hinged connection with the lever arm linkages 1272a-c and may be manually adjusted to vary a position of the lever arm linkages 1272a-c. FIG. 32, for example, illustrates the lever arm linkages 1272a-c expanded radially outward.

In operation, each lever arm linkage 1272a-c may include a respective first portion 1278a-c that is coupled to the central linkage support 1276. Each lever arm linkage 1272a-c may include a respective second portion 1280a-c that may be coupled to the base 1277. The central linkage support 1276 may be configured to move towards the base 1277 to extend each lever arm linkage 1272a-c radially outward. Similarly, the central linkage support 1276 may be configured to move away from the base 1277 to retract each lever arm linkage 1272a-c radially inward.

In examples, the engagement assembly 1262 may include a pneumatic system. The pneumatic system may be configured to produce an engagement force with the tube 1100 to engage with the tube 1100. The force may be a suction force (e.g., negative air pressure). Referring to FIG. 30 and the side cross sectional view of FIG. 31, the pneumatic system may include one or more pneumatic conduits 1282, 1284a-c in examples. The pneumatic system may further include a pneumatic conduit 1150 and a pneumatic source 1152 as represented in FIG. 17 for example. The pneumatic system may produce a pressure that may be applied to produce a suction force for the suction devices 1270a-c.

The pneumatic conduit 1282 may extend through the rotary union housing 1266 and may be in pneumatic communication with the pneumatic conduits 1284a-c. The pneumatic conduit 1282 may comprise a manifold that extends to each of the conduits 1284a-c, with the branching occurring at the base 1277. The pneumatic conduit 1282 may be in pneumatic communication with the pneumatic port 1283 that may be positioned on the rotary union housing 1266. The pneumatic connection between the conduit 1282 and the port 1283 may be rotational, in that the conduit 1282 may rotate yet remain in pneumatic communication with the port 1283. The pneumatic port 1283 may be connected with a conduit 1150 and a pneumatic source 1152 as described in regard to the port 1154.

The pneumatic conduits 1284a-c may comprise one or more hoses or other forms of conduits extending to the respective suction device 1270a-c.

In operation, the pneumatic source 1152 may apply the pneumatic pressure to the respective suction devices 1270a-c. The suction devices 1270a-c may apply the suction force to the interior surface of the tube. The lever arm linkages 1272a-c may be moved radially outward such that the suction devices 1270a-c contact the interior surface of the tube 1100. The suction may be applied for a desired duration of the testing procedure. The suction may be released and the lever arm linkages 1272a-c may be moved radially inward as desired. Other configurations may be utilized in examples.

Referring to FIG. 30, the engagement assembly 1262 may include a base 1277 or manifold housing that may support the one or more arm assemblies 1268a-c. The one or more arm assemblies 1268a-c may extend radially outward from the base 1277.

The engagement assembly 1262 may be configured to rotate with the tube 1100 upon being engaged with the tube 1100. For example, referring to FIG. 31, the encoder system 1260 may include a rotational bearing 1290 that allows at least a portion of the engagement assembly 1262 to rotate with the tube 1100. The rotary union housing 1266, for example, may remain rotationally static during a testing procedure, with the base 1277, and rotating shaft 1264 rotating with the tube 1100. Other configurations may be utilized as desired.

The rotary encoder 1122 may be configured to detect the rotary position of the engagement assembly 1262 to detect the rotary position of the tube 1100 as disclosed herein. Methods as disclosed regarding the rotary encoder system 1120 may be utilized for testing the tube 1100.

In examples, the arm assemblies 1268a-c may include at least three of the arm assemblies 1268a-c and accordingly at least three of the lever arm linkages 1272a-c spaced circumferentially from each other. Other configurations may be utilized in examples (e.g., a greater or lesser number of arm assemblies or lever arm linkages as desired).

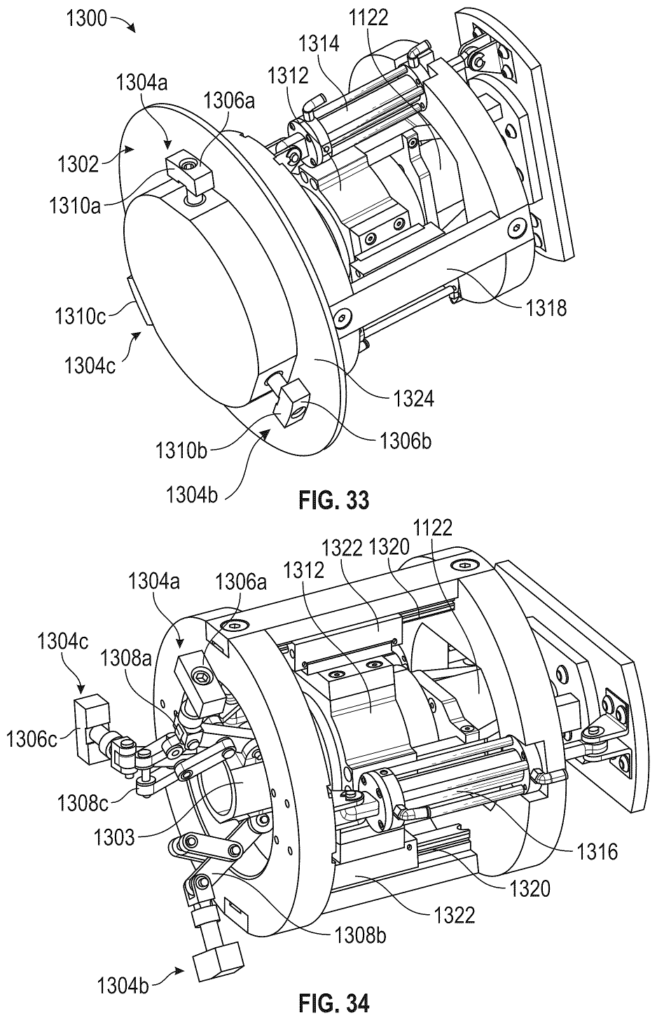

Other variations of encoder systems may be utilized in examples. FIG. 33, for example, illustrates a variation that may include the features of the encoder system 1120 and operate in a similar manner as the encoder system 1120 unless stated otherwise. The rotary encoder system 1300 may include the rotary encoder 1122 and may include an engagement assembly 1302. A rotating shaft 1303 may extend from the encoder 1122 to the engagement assembly 1302 in examples. The engagement assembly 1302 may be configured to engage with the tube 1100. The engagement assembly 1302 may apply a radial force for engagement with the interior surface 1114 of the tube 1100. The engagement assembly 1302 may be configured to engage with the interior surface 1114 of the tube 1100 in examples. At least a portion of the engagement assembly 1302 may insert into the interior channel 1104 of the tube 1100 in examples, to engage with the interior surface 1114 of the tube 1100. Other configurations may be utilized as desired.

The engagement assembly 1302 may include one or more arm assemblies (e.g., arm assemblies 1304a-c) in examples. The one or more arm assemblies 1304a-c may be configured for engagement with the tube 1100. Each arm assembly 1304a-c may be configured to apply a radially outward force to the tube 1100 to engage with the tube 1100. Each arm assembly 1304a-c may be configured to move radially outward for engagement with the tube 1100. Each arm assembly 1304a-c may include a respective friction surface 1306a-c for applying friction to the tube 1100 to engage with the tube 1100.

Each arm assembly 1304a-c may include a respective lever arm linkage 1308a-c (marked in FIG. 34). Each lever arm linkage 1308a-c may be configured to extend radially outward towards an interior surface of the tube 1100. Each lever arm linkage 1308a-c may comprise a scissor linkage or another form of linkage as desired. The linked supports may be in an “X” pattern or another pattern as desired. Each friction surface 1306a-c may be positioned on a respective one of the lever arm linkages 1308a-c. Each lever arm linkage 1308a-c may include a respective head portion 1310a-c upon which the respective friction surface 1306a-c may be positioned. Other configurations may be utilized in examples.

The respective lever arm linkage 1308a-c may be configured to radially expand or contract upon axial movement of a slide housing 1312. The slide housing 1312 may house the rotating shaft 1303 and the rotating shaft may rotate relative to the slide housing 1312 with the slide housing 1312 remaining rotationally static. An axial advancement of the slide housing 1312 may produce a radially outward expansion of the respective lever arm linkage 1308a-c and an axial retraction may produce a radially inward retraction of the respective lever arm linkage 1308a-c. Other configurations may be utilized in examples.

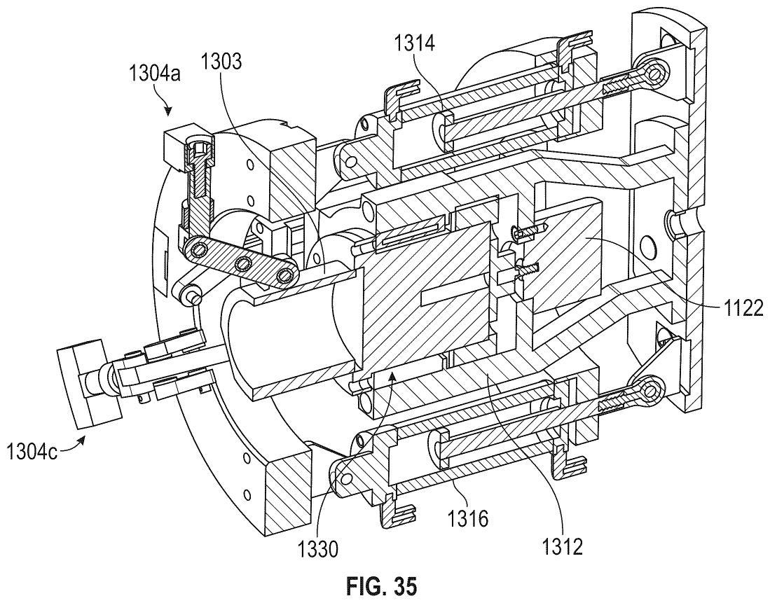

In examples, the engagement assembly 1302 may include a pneumatic system. The pneumatic system may be configured to produce an engagement force with the tube 1100 to engage with the tube 1100. The force may be a radially outward force. For example, the pneumatic system may be configured to move the one or more arm assemblies 1304a-c radially outward to engage with the tube 1100. Referring to the side cross sectional view of FIG. 35, the pneumatic system may include one or more pneumatic actuators 1314, 1316 in examples. The pneumatic actuators 1314, 1316 may include one or more ports for pneumatic connection with a pneumatic source 1152. The pneumatic system may further include a pneumatic conduit 1150 and the pneumatic source 1152 as represented in FIG. 17 for example. The pneumatic system may produce a pressure that may be applied to drive the pneumatic actuators 1314, 1316 and the one or more arm assemblies 1304a-c radially outward for friction with the tube 1100.

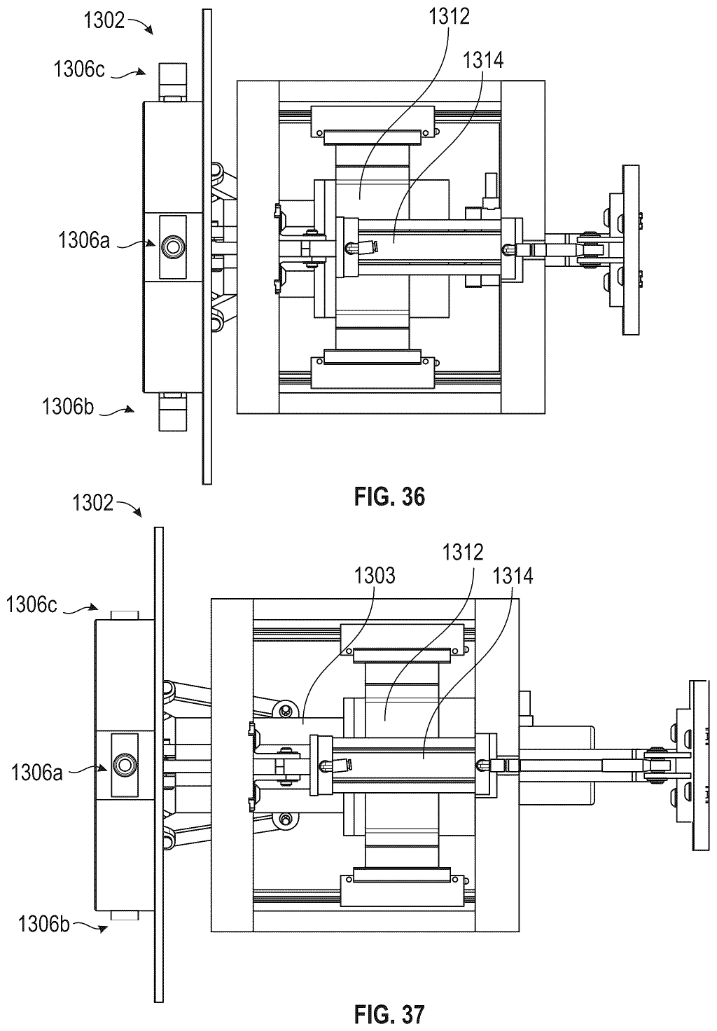

The pneumatic actuators 1314, 1316 may be positioned outward of the slide housing 1312 in examples. One end of each of the pneumatic actuators 1314, 1316 may be coupled to a mount 1318. The other end of each of the pneumatic actuators 1314, 1316 may be coupled to the slide housing 1312. As such, an expansion of the pneumatic actuators 1314, 1316 causes the slide housing 1312 to axially displace relative to the mount 1318 thus causing the one or more arm assemblies 1304a-c to actuate. FIG. 36, for example, illustrates the arm assemblies 1304a-c in an extended position with the pneumatic actuators 1314, 1316 in a retracted configuration. FIG. 37 illustrates the arm assemblies 1304a-c in a retracted position with the pneumatic actuators 1314, 1316 in an extended configuration.

Each pneumatic actuator 1314, 1316 may comprise a piston and cylinder that may expand or contract due to the pneumatic pressure. Other configurations of pneumatic actuators 1314, 1316 may be utilized in examples.

The slide housing 1312 may be configured to slide relative to the mount 1318 along rails 1320. The rails 1320 may be positioned on the mount 1318. The slide housing 1312 may include sliders 1322 configured to slide along the rails 1320.

Referring to FIG. 33, the engagement assembly 1302 may include a base 1324 or a plate that may support the one or more arm assemblies 1304a-c. The base 1324 may have a circular outer profile or may have another configuration as desired. The circular outer profile may allow the base 1324 to fit within the interior channel 1104 of the tube 1100 in a testing procedure. Other configurations may be utilized as desired.

The engagement assembly 1302 may be configured to rotate with the tube 1100 upon being engaged with the tube 1100. For example, referring to FIG. 35, the encoder system 1300 may include a rotational bearing 1330 that allows at least a portion of the engagement assembly 1302 to rotate with the tube 1100. The rotational bearing 1330 may allow the rotating shaft 1303 to rotate relative to the slide housing 1312. The mount 1318 and slide housing 1312, for example, may remain rotationally static during a testing procedure, with the rotating shaft 1303 rotating with the tube 1100. Other configurations may be utilized as desired.

The rotary encoder 1122 may be configured to detect the rotary position of the engagement assembly 1302 to detect the rotary position of the tube 1100 as disclosed herein. Methods as disclosed regarding the rotary encoder system 1120 may be utilized for testing the tube 1100.

In examples, the arm assemblies 1304a-c may include at least three of the arm assemblies 1304a-c and accordingly at least three of the lever arm linkages 1308a-c spaced circumferentially from each other. Other configurations may be utilized in examples (e.g., a greater or lesser number of arm assemblies or lever arm linkages as desired).

Other variations may be utilized.

In examples, the rotary encoder systems of FIGS. 13-37 may be utilized with any non-direct drive system, such as system 300, and with ferrous or non-ferrous tubes. In examples, the rotary encoder systems of FIGS. 13-37 may be utilized with structures other than tubes that may undergo a testing procedure herein. Other configurations may be utilized as desired.

In examples, a method may be utilized for testing for the presence of a tube defect. The method may include arranging at least a portion of a tube in a measuring position relative to a plurality of rollers and an encoder system of a non-direct drive ultrasonic scanning system. The method may include engaging an engagement assembly of the encoder system with an interior surface of the tube. The method may include spinning, by the plurality of rollers, the tube. The method may include moving an ultrasonic transducer into proximity with the tube. The method may include detecting, by the encoder system, a rotary position of a portion of the tube. The method may include synchronizing, based on the rotary position, rotational and translational motion of an ultrasonic transducer of the non-direct drive ultrasonic scanning system. The method may include determining, using the rotary position and signals from the ultrasonic transducer of the non-direct drive ultrasonic scanning system, whether a defect of the tube is present. The method may utilize any of the encoder systems or other features disclosed herein. The method may be varied as desired.

Features of the various examples may be utilized solely or in combination or substitution with each other as desired. For example, any of the features of FIGS. 13-37 may be utilized solely or in combination with any other feature disclosed herein.

In the description herein, numerous specific details are set forth. However, it is to be understood that examples of the present disclosure may be practiced without these specific details. In other instances, well-known methods, structures, and techniques have not been shown in detail in order not to obscure an understanding of this description. References to “one example,” “an example,” “examples,” “some examples,” “certain examples,” “various examples,” etc., indicate that the example(s) of the present disclosure so described may include a particular feature, structure, or characteristic, but not every example necessarily includes the particular feature, structure, or characteristic. Further, repeated use of the phrase “in one example” does not necessarily refer to the same example, although it may.

Throughout the specification and the claims, the following terms take at least the meanings explicitly associated herein, unless the context clearly dictates otherwise. The term “or” is intended to mean an inclusive “or. ” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Certain examples of the present disclosure are described above with reference to block and flow diagrams of systems and methods and/or computer program products according to examples of the present disclosure. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some examples of the present disclosure.

These computer-executable program instructions may be loaded onto a general-purpose computer, a special-purpose computer, a processor (e.g., a processor chip, single/multi-processor architectures, sequential (Von Neumann)/parallel architectures, and specialized circuits, etc.), or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that may direct a computer or other programmable data processing apparatus to function in a particular manner, such that the instructions stored in the computer-readable memory produce an article of manufacture including instruction means that implement one or more functions specified in the flow diagram block or blocks.

As an example, the present disclosure may provide for a computer program product, including a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Various aspects described herein may be implemented using standard programming and/or engineering techniques to produce software, firmware, hardware, and/or any combination thereof to control a computing device to implement the disclosed subject matter. A computer-readable medium may include, for example: a magnetic storage device such as a hard disk, a floppy disk or a magnetic strip; an optical storage device such as a compact disk (CD) or digital versatile disk (DVD); a smart card; and a flash memory device such as a card, stick or key drive, or embedded component. Additionally, it should be appreciated that a carrier wave may be employed to carry computer-readable electronic data including those used in transmitting and receiving electronic data such as streaming video or in accessing a computer network such as the Internet or a local area network (LAN). Of course, a person of ordinary skill in the art will recognize many modifications may be made to this configuration without departing from the scope or spirit of the claimed subject matter.

While certain examples of the present disclosure have been described in connection with what is presently considered to be the most practical and various examples, it is to be understood that the present disclosure is not to be limited to the disclosed examples, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain examples of the present disclosure, including the best mode, and also to enable any person skilled in the art to practice certain examples of the present disclosure, including making and using any devices or systems and performing any incorporated methods. The patentable scope of certain examples of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The specific configurations, choice of materials and the size and shape of various elements can be varied according to particular design specifications or constraints requiring a system or method constructed according to the principles of the disclosed technology. Such changes are intended to be embraced within the scope of the disclosed technology. The presently disclosed examples, therefore, are considered in all respects to be illustrative and not restrictive. It will therefore be apparent from the foregoing that while particular forms of the disclosure have been illustrated and described, various modifications can be made without departing from the spirit and scope of the disclosure and all changes that come within the meaning and range of equivalents thereof are intended to be embraced therein.

For purposes of this description, certain aspects, advantages, and novel features of the examples of this disclosure are described herein. The disclosed methods, apparatuses, and systems should not be construed as limiting in any way. Instead, the present disclosure is directed toward all novel and nonobvious features and aspects of the various disclosed examples, along and in various combinations and sub-combinations with one another. The methods, apparatuses, and systems are not limited to any specific aspect or feature or combination thereof, nor do the disclosed examples require that any one or more specific advantages be present or problems be solved. Features, elements, or combinations of one example can be combined into other examples herein.

Example 1: A non-direct drive tube defect detection system, comprising: a non-direct drivetrain system comprising a plurality of rollers rotatably driven by a shaft, the plurality of rollers configured to receive and cause a tube to spin while rested thereon; and an encoder system including an engagement assembly for engaging with an interior surface of the tube, the encoder system configured to detect a rotary position of a portion of the tube.

Example 2. The system of any example herein, in particular Example 1, wherein the engagement assembly is configured to apply a radial force to the tube to engage with the tube.

Example 3. The system of any example herein, in particular Example 1, wherein the engagement assembly includes one or more friction surfaces for applying friction to the tube to engage with the tube.

Example 4. The system of any example herein, in particular Example 1, wherein the engagement assembly includes one or more suction devices for applying suction to the tube to engage with the tube.

Example 5. The system of any example herein, in particular Example 1, wherein the engagement assembly includes one or more arm assemblies for engagement with the tube.

Example 6. The system of any example herein, in particular Example 5, wherein each arm assembly includes a friction surface for applying friction to the tube to engage with the tube.

Example 7. The system of any example herein, in particular Example 5, wherein each arm assembly is configured to move radially outward for engagement with the tube.

Example 8. The system of any example herein, in particular Example 5, wherein each arm assembly includes a suction device for engagement with the tube.

Example 9. The system of any example herein, in particular Example 5, wherein each arm assembly is configured to be positioned within an interior channel of the tube.

Example 10. The system of any example herein, in particular Example 1, wherein the engagement assembly includes a pneumatic system.

Example 11. The system of any example herein, in particular Example 10, wherein the pneumatic system is configured to produce an engagement force with the tube to engage with the tube.

Example 12. The system of any example herein, in particular Example 11, wherein the engagement force is a radially outward force.

Example 13. The system of any example herein, in particular Example 11, wherein the engagement force is a suction force.

Example 14. The system of any example herein, in particular Example 10, wherein the engagement assembly includes one or more arm assemblies and the pneumatic system is configured to move the one or more arm assemblies radially outward to engage with the tube.

Example 15. The system of any example herein, in particular Example 14, wherein the engagement assembly includes one or more springs configured to retract the one or more arm assemblies radially inward.

Example 16. The system of any example herein, in particular Example 14, wherein the pneumatic system is configured to apply force to a mechanical interface to move the one or more arm assemblies radially outward to engage with the tube.

Example 17. The system of any example herein, in particular Example 10, wherein the pneumatic system includes a pneumatic actuator.

Example 18. The system of any example herein, in particular Example 1, wherein the engagement assembly includes at least one lever arm linkage.

Example 19. The system of any example herein, in particular Example 18, wherein the at least one lever arm linkage is configured to extend radially outward towards an interior surface of the tube.

Example 20. The system of any example herein, in particular Example 18, wherein the engagement assembly includes a pneumatic actuator, and the at least one lever arm linkage includes a first portion coupled to the pneumatic actuator and a second portion coupled to a base, and the pneumatic actuator is configured to move towards the base to extend the at least one lever arm linkage radially outward.

Example 21. The system of any example herein, in particular Example 20, wherein the at least one lever arm linkage includes at least three lever arm linkages spaced circumferentially from each other.

Example 22. The system of any example herein, in particular Example 18, wherein the at least one lever arm linkage is configured to slide along at least one rail to extend radially outward towards the interior surface of the tube.

Example 23. The system of any example herein, in particular Example 18, wherein the at least one lever arm linkage is a scissor linkage.

Example 24. The system of any example herein, in particular Example 23, wherein the at least one lever arm linkage includes two of the scissor linkages each configured to expand in opposite directions from each other.

Example 25. The system of any example herein, in particular Example 18, further comprising a friction surface coupled to the at least one lever arm linkage for applying friction to the tube to engage with the tube.

Example 26. The system of any example herein, in particular Example 18, further comprising a suction device coupled to the at least one lever arm linkage for engagement with the tube.

Example 27. The system of any example herein, in particular Example 26, wherein the at least one lever arm linkage includes at least three of the lever arm linkages spaced circumferentially from each other, and the system further comprises at least three suction devices each being coupled to a respective one of the at least three lever arm linkages.

Example 28. The system of any example herein, in particular Example 1, wherein the encoder system includes a rotational bearing configured to allow at least a portion of the engagement assembly to rotate with the tube.

Example 29. The system of any example herein, in particular Example 1, wherein the encoder system includes a rotary encoder configured to detect the rotary position of the portion of the tube.

Example 30. The system of any example herein, in particular Example 29, wherein the rotary encoder is configured to detect a rotary position of the engagement assembly to detect the rotary position of the portion of the tube.

Example 31. The system of any example herein, in particular Example 1, further comprising: an adjustable receiving/transmitting transducer positioned to mount proximal to the tube.

Example 32. The system of any example herein, in particular Example 1, wherein the non-direct drivetrain system comprises a motor coupled to a gear box, wherein the gear box is coupled to an output shaft that passes through a bearing housing mounted in a wall of a fluid tank and into contact with the plurality of rollers.

Example 33. The system of any example herein, in particular Example 1, further comprising a fluid tank for providing fluid for use in testing operations.

Example 34. The system of any example herein, in particular Example 1, further comprising the tube.

Example 35. The system of any example herein, in particular Example 34, wherein at least a portion of the engagement assembly is configured to be positioned within an interior channel of the tube.

Example 36. A method of testing for the presence of a tube defect, comprising: arranging at least a portion of a tube in a measuring position relative to a plurality of rollers and an encoder system of a non-direct drive ultrasonic scanning system; engaging an engagement assembly of the encoder system with an interior surface of the tube; spinning, by the plurality of rollers, the tube; moving an ultrasonic transducer into proximity with the tube; detecting, by the encoder system, a rotary position of a portion of the tube; synchronizing, based on the rotary position, rotational and translational motion of an ultrasonic transducer of the non-direct drive ultrasonic scanning system; and determining, using the rotary position and signals from the ultrasonic transducer of the non-direct drive ultrasonic scanning system, whether a defect of the tube is present.

Example 37. The method of any example herein, in particular Example 36, wherein the encoder system is any encoder system according to any of Examples 1 to 35.

Example 38. The method of any example herein, in particular Example 36, wherein the tube is any tube according to any of Examples 1-35.

Example 39. The method of any example herein, in particular Example 36, further comprising: detecting, by the ultrasonic transducer, a set of signals resulting from a set of ultrasonic pulses.

Example 40. The method of any example herein, in particular Example 36, further comprising positioning at least a portion of the engagement assembly within an interior channel of the tube.

Any of the features of any of the examples, including but not limited to any of the first through 40 examples referred to above, is applicable to all other aspects and examples identified herein, including but not limited to any examples of any of the first through 40 examples referred to above. Moreover, any of the features of an example of the various examples, including but not limited to any examples of any of the first through 40 examples referred to above, is independently combinable, partly or wholly with other examples described herein in any way, e.g., one, two, or three or more examples may be combinable in whole or in part. Further, any of the features of the various examples, including but not limited to any examples of any of the first through 40 examples referred to above, may be made optional to other examples. Any example of a method can be performed by a system or apparatus of another example, and any aspect or example of a system or apparatus can be configured to perform a method of another aspect or example, including but not limited to any examples of any of the first through 40 examples referred to above.

1. A non-direct drive tube defect detection system, comprising:
a non-direct drivetrain system comprising a plurality of rollers rotatably driven by a shaft, the plurality of rollers configured to receive and cause a tube to spin while rested thereon; and
an encoder system including an engagement assembly for engaging with an interior surface of the tube, the encoder system configured to detect a rotary position of a portion of the tube.

2. The system of claim 1, wherein the engagement assembly is configured to apply a radial force to the tube to engage with the tube.

3. The system of claim 1, wherein the engagement assembly includes one or more friction surfaces for applying friction to the tube to engage with the tube.

4. The system of claim 1, wherein the engagement assembly includes one or more suction devices for applying suction to the tube to engage with the tube.

5. The system of claim 1, wherein the engagement assembly includes one or more arm assemblies for engagement with the tube.

6.-10. (canceled)

11. The system of claim 1, wherein the engagement assembly includes a pneumatic system, and wherein the pneumatic system is configured to produce an engagement force with the tube to engage with the tube.

12. (canceled)

13. (canceled)

14. The system of claim 1, wherein the engagement assembly includes a pneumatic system, and wherein the engagement assembly includes one or more arm assemblies and the pneumatic system is configured to move the one or more arm assemblies radially outward to engage with the tube.

15.-18. (canceled).

19. The system of claim 1, wherein the engagement assembly includes at least one lever arm linkage, and wherein the at least one lever arm linkage is configured to extend radially outward towards an interior surface of the tube.

20. The system of claim 1, wherein the engagement assembly includes at least one lever arm linkage, and wherein the engagement assembly includes a pneumatic actuator, and the at least one lever arm linkage includes a first portion coupled to the pneumatic actuator and a second portion coupled to a base, and the pneumatic actuator is configured to move towards the base to extend the at least one lever arm linkage radially outward.

21. The system of claim 20, wherein the at least one lever arm linkage includes at least three lever arm linkages spaced circumferentially from each other.

22.-27. (canceled)

28. The system of claim 1, wherein the encoder system includes a rotational bearing configured to allow at least a portion of the engagement assembly to rotate with the tube.

29. The system of claim 1, wherein the encoder system includes a rotary encoder configured to detect the rotary position of the portion of the tube.

30. The system of claim 29, wherein the rotary encoder is configured to detect a rotary position of the engagement assembly to detect the rotary position of the portion of the tube.

31. The system of claim 1, further comprising:
an adjustable receiving/transmitting transducer positioned to mount proximal to the tube.

32. (canceled)

33. The system of claim 1, further comprising a fluid tank for providing fluid for use in testing operations.

34. (canceled)

35. The system of claim 1, further comprising the tube, and wherein at least a portion of the engagement assembly is configured to be positioned within an interior channel of the tube.

36. A method of testing for the presence of a tube defect, comprising:
arranging at least a portion of a tube in a measuring position relative to a plurality of rollers and an encoder system of a non-direct drive ultrasonic scanning system;
engaging an engagement assembly of the encoder system with an interior surface of the tube;
spinning, by the plurality of rollers, the tube;
moving an ultrasonic transducer into proximity with the tube;
detecting, by the encoder system, a rotary position of a portion of the tube;
synchronizing, based on the rotary position, rotational and translational motion of an ultrasonic transducer of the non-direct drive ultrasonic scanning system; and
determining, using the rotary position and signals from the ultrasonic transducer of the non-direct drive ultrasonic scanning system, whether a defect of the tube is present.

37. The method of claim 36, wherein the encoder system is any encoder system according to any of claims 1 to 35.

38. (canceled)

39. The method of claim 36, further comprising:
detecting, by the ultrasonic transducer, a set of signals resulting from a set of ultrasonic pulses.

40. The method of claim 36, further comprising positioning at least a portion of the engagement assembly within an interior channel of the tube.
